(19) United States
(12) Patent Application Publication
(10) Pub. No.: US 2024/0106839 A1
(43) Pub. Date: Mar. 28, 2024

(54) CYBER-PHYSICAL PROTECTIONS FOR EDGE COMPUTING PLATFORMS

(71) Applicant: Intel Corporation, Santa Clara, CA (US)

(72) Inventors: Ned M. Smith, Beaverton, OR (US); Sunil Cheruvu, Tempe, AZ (US); Gerald Alan Rogers, Chandler, AZ (US); Victor Medrano, Marana, AZ (US); Kshitij Arun Doshi, Tempe, AZ (US)

(21) Appl. No.: 17/954,133

(22) Filed: Sep. 27, 2022

(51) Int. Cl. H04L 9/40

(52) U.S. Cl. CPC H04L 63/1416; H04L 63/1441

(57) ABSTRACT

Various systems and methods are described to enable cyber-physical protections in edge computing platforms, including with countermeasures that mitigate and halt a variety of digital or real-world attacks. In an example, an attack detection and response engine is used to monitor processing circuitry, with operations that: identify operational data from processing circuitry that operates multiple layers (e.g., of an IP block) to perform compute operations, with trust of the processing circuitry established based on attestation of a hardware root of trust (RoT); evaluate the operational data to identify an attack condition at the processing circuitry, based on monitoring an operational layer of the multiple layers; and provide a digital attack response to the processing circuitry, in response to identifying the attack condition, to deploy the digital attack response and cause a countermeasure at the operational layer of the processing circuitry.

### TECHNICAL FIELD

Embodiments described herein generally relate to data processing in networked computing environments, and in particular, to the use of physical response mechanisms to assist the security and trustworthiness of computing entities and assets.

### BACKGROUND

Edge computing deployments often lack physical security protections. As one example, some base stations lack on-site security personnel and may not have fenced or walled security perimeters. Lack of physical security puts user data and workloads at increased risk. Consequently, real-world computing deployments, such as those provided by “edge computing” and related “edge”, “edge-cloud”, and “near-cloud” environments, are in need of improved tamper prevention, detection, and response mechanisms.

Edge computing, at a general level, refers to the transition of compute and storage resources closer to endpoint devices (e.g., consumer computing devices, user equipment, etc.), in order to optimize total cost of ownership, reduce application latency, improve service capabilities, and improve compliance with security or data privacy requirements. Edge computing may, in some scenarios, provide a cloud-like distributed service that offers orchestration and management for applications among many types of storage and compute resources. As a result, some implementations of edge computing have been referred to as the “edge cloud” or the “fog”, as powerful computing resources previously available only in large remote data centers are moved closer to endpoints and made available for use by consumers at the “edge” of the network.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawings in which:

FIG. 1 illustrates a layered security model for a computing system, according to an example;

FIG. 2 illustrates an attack detection and response engine architecture, according to an example;

FIG. 3 illustrates a flowchart of a method for enabling an attack detection and response operations with processing circuitry, according to an example;

FIG. 4 illustrates detection and response flows for detecting attack conditions and implementing cyber-physical protections in various hardware of a computing system, according to an example;

FIG. 5 illustrates a flowchart of a method for implementing a cyber-physical protection with an attack detection and response engine, according to an example;

FIG. 6 illustrates a confidential computing overview providing a comparison of trust and identify verification, according to an example;

FIG. 7 illustrates hardware and functional components used in connection with operations of a trust authority, according to an example;

FIG. 8 illustrates a software stack used in connection with trust verification services, according to an example;

FIG. 9 illustrates a workflow of a use case for a trust verification service, according to an example;

FIG. 10 illustrates an overview of an architecture for implementing Trust-as-a-Service (TaaS) features in a Software-as-a-Service (SaaS) deployment, according to an example;

FIG. 11 illustrates an overview of an edge cloud configuration for edge computing, according to an example;

FIG. 12 illustrates deployment and orchestration for virtual edge configurations across an edge-computing system operated among multiple edge nodes and multiple tenants, according to an example;

FIG. 13 illustrates a vehicle compute and communication use case involving mobile access to applications in an edge-computing system, according to an example;

FIG. 14 illustrates a block diagram depicting deployment and communications among several Internet of Things (IoT) devices, according to an example;

FIG. 15 illustrates an overview of layers of distributed compute deployed among an edge computing system, according to an example;

FIG. 16 illustrates an overview of example components deployed at a compute node system, according to an example;

FIG. 17 illustrates a further overview of example components within a computing device, according to an example; and

FIG. 18 illustrates a software distribution platform to distribute software instructions and derivatives, according to an example.

### DETAILED DESCRIPTION

In the following description, methods, configurations, and related apparatuses are disclosed for enabling and utilizing cyber-physical protections in a variety of networked computing systems. The following specifically provides a layered approach to detection and response for attacks or threats. Various types of sensors can be applied to chassis, logic boards, and System-on-Chip (SoC) and Multi-Chip package (MCP) processing circuitry to trigger responses at specific layers of hardware. These responses, in turn, may lock down (e.g., disable) a system or component, or may apply confidentiality or integrity protection to user data, secrets, and workloads before sophisticated attacks can be applied.

The following invokes the use of attack detection mitigations and responses in embedded control mechanisms (e.g., field programmable gate arrays (FPGAs), Application Specific Integrated Circuits (ASICs), Complex Programmable Logic Devices (CPLDs), Network Interface Cards (NICs), Wide-area-network (WAN) or 5G (cellular wireless network) controllers), which include or are accessible to tamper detection or response technology. Such technology may be integrated with other systems that provide early warning to both remote monitoring stations and to local computing equipment. The following use of attack detection sensors anticipate multiple types of attacks and attackers, whether cyber, cyber-physical, or physical. Once detected, a response may trigger the transmission of a countermeasure referred to herein as a “digital poison capsule” (DPC).

In a specific example, a DPC is implemented by a notification message on an ephemeral secure IPC channel, which is sent to a response agent such as a SoC or MCP, or peripheral or peer server. The DPC activates a number of enforcement actions at the response agents to protect the assets affected by the cyber/cyber-physical/physical attacks. For instance, a priority interrupt handler may override all existing task scheduling behaviors, encrypt user data, and deliver an escrow key to a remote base station or core server as a result of the DPC. Further, a listener/watchdog process on peer nodes (i.e., on the SoC, MCP, peripheral or peer server) receives the DPC message and performs proactive response processing. These types of responses may cascade through layers of devices at each peer node in order to stop or respond to the attack.

Such approaches bolster the value of many types of processing circuitry for high-security deployments, including the use of edge nodes in hostile environments and by nation state-owned systems. The following approaches also enable edge systems to be deployed in remote unattended locations with greater confidence that user data, workloads and digital IP will not be lost or compromised. This reduces the risk of exposure of secrets, key material and IP to nation state adversaries and other attackers. These and other accompanying security and operational benefits will be apparent from the following description.

Overview of Computing System Attacks and Security Risks

As an overview of security risks and response mechanisms, the following terminology is introduced for this document.

Tamper prevention features refer to mechanisms that ensure detection and response mechanisms are reliable and resist physical attack. Tamper prevention typically involves some combination of tamper detection features and tamper response features.

Tamper detection features refer to mechanisms that can obtain or collect data to identify an attack involving a physical aspect. Such features may affect many hardware or operational layers, surrounding premises, chassis, probing using exposed debug/JTAG ports, or more sophisticated physical attacks that involve removal of logic boards, Multiple Chip Packages (MCP) or SoCs (e.g., where sophisticated sanding techniques may remove packaging or silicon layers).

Tamper response features refer to mechanisms that can respond to or notify of an attack involving a physical aspect. Such features may notify external management entities, increase logging and monitoring granularity or lock out would be intruders. Edge systems may be physically far away from security personnel, or attacks may involve insiders who normally have physical access, such as maintenance personnel. Hence, response mechanisms must notify multiple stakeholders.

Cyber-physical attacks (CPA) refer to an attack that involves some type of electronic (e.g., networked) access obtained through physical access. A CPA may be possible when attackers have physical access to logic boards, debugging ports or other physical interfaces. CPA threats aim to gain access to data such as encryption keys, intellectual property or trade secrets. CPA attackers may perform sophisticated side-channel analysis or may install attack hardware that enables clandestine remote cyber attacking. CPAs can include: polluting or corrupting data; hijacking control either by compromising physical integrity of a machine; using rootkits to take over logical or administrative control; side-channel analysis to steal keys/secrets; installing attack chips, firmware, or software. As will be understood, rootkit attacks may not be limited to edge infrastructure, but may present a greater threat due to physical access. Often CPA attackers have limited time and access credentials. Therefore, CPA attacks may be narrowly focused and difficult to detect. Given a toehold however, later software-only attacks can broaden the scope of compromise.

Physically present cyber attacks (PPCA) are a similar type of attack, that may occur due to physical access to logic boards, debugging ports, or other physical interfaces. PPCA threats typically aim to gain access to data such as encryption keys, intellectual property, or trade secrets. Attackers may perform sophisticated side-channel analysis or to install attack hardware that enables clandestine remote cyber attacking.

The following discusses automated detection and response mechanisms aimed at transitioning SoC and MCP components to a safer “locked down” state before CPA or PPCA attackers can penetrate physical layers. A transition to “lock down” states typically remove or secures secrets or customer data, particularly for edge computing systems operating in remote or inaccessible locations.

Edge computing systems are often deployed in environments lacking physical security (e.g., consider that base stations typically do not have on-site security personnel). Lack of physical security places user data and workloads at increased risk due to attackers that may gain physical access to computing systems. Attacks also may involve insiders who normally have physical access, such as maintenance personnel. Accordingly, there are often two parts to the problem, (1) attack/tamper detection and (2) response mechanisms. Response to a detected physical attack, in particular, often is a significant challenge, because edge systems may be physically far away from security personnel.

Besides the aim of stealing data and keys, other aims of attackers might include (a) polluting or corrupting data, and (b) hijacking control either by compromising physical integrity of a machine, or through rootkits to take over logical (software-based) administrative control of a machine. While rootkit attacks are not limited to edge infrastructure, its greater vulnerability to physical attacks means that devices may be compromised by a disgruntled insider, who may then proceed to install a rootkit unobserved. Often such an attacker may only have a limited amount of time, or limited set of credentials for targeting a specific device, and therefore may plan a narrow attack at the time of physical intrusion but broaden the attack later. Prevention is thus offered as an element of the following approaches, to ensure that detection and response mechanisms are reliable (e.g., resistant to physical attackers).

The following introduces automated detection and response mechanisms aimed at transitioning SoC and MCP components to a safer “lock down” state before the attacker is able to attack the logic layers. Primarily, the transition into a “lock down” state removes access to secrets or customer data. Accordingly, these techniques may be applied at various operational or hardware layers—to a trusted execution environment (TEE), to a server class chip or IoT chip, to a computing device—or anything in between. The present techniques, in fact, can be applicable to any kind of device and processing circuitry that could be deployed in or to an edge, and any type of a workload that operates on such a device and processing circuitry. Here, a “workload” is considered as a main abstraction for some compute operation, as the objective is to ensure a secure and un-tampered location to host the workload in terms of the computing hardware.

The following also addresses the specialized needs of Edge computing where layered attack detection and responses are possible utilizing Edge connectivity and low latency to greatest advantage. Other proposed approaches (typically for military applications) propose use of some physical countermeasure such as a thermite charge that completely destroys the device when physical attack is detected. However, the release of a thermite explosion may result in collateral damage to peer servers, base station or other tower equipment. The presently described use of detection sensors enable the use of layered responses, to limit effects on a particular layer or component of hardware.

Detection and Response in a Layered Physical Computing System

Many datacenters today deploy sensors and mechanisms to identify intrusion detection, unauthorized facility access, proximity sensors, tampering attempts, power control attempts, and the like. Actions usually include self-destruct capabilities, power down, alarm activation, or law enforcement notification. However, despite these mechanisms, there are not suitable integration of existing approaches to precisely detect and respond to attacks. In the following examples, the use of a DPC can provide a more precise and targeted measure to respond to such attacks in processing hardware. This may be provided by the delegation of security and response tasks to another hardware, such as a configured field programmable gate array (FPGA), Application Specific Integrated Circuit (ASIC), or Complex Programmable Logic Device (CPLD) which operates an Attack Detection and Response Engine (ADRE).

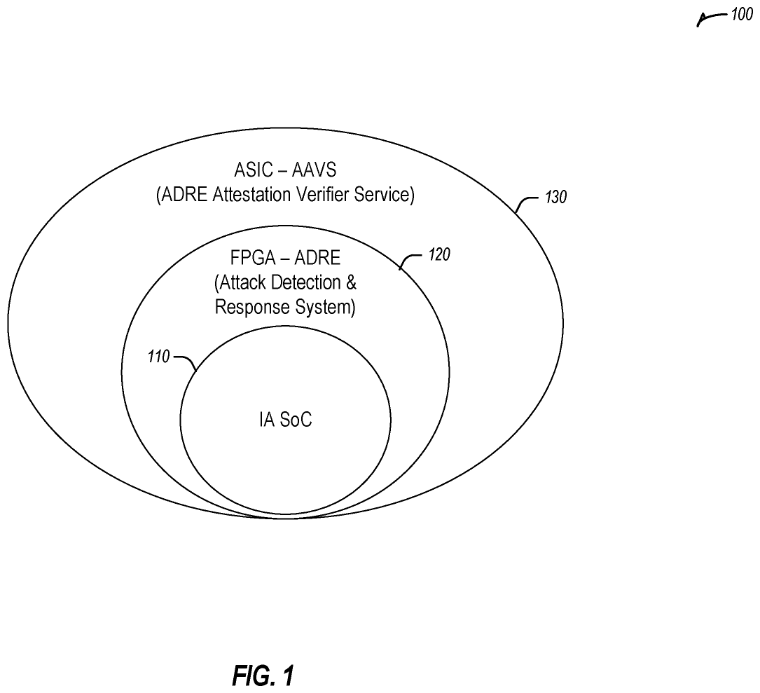

FIG. 1 depicts an example multi-layered security model, where the processing circuitry to be monitored and protected is a system-on-chip (SoC). Conceptually, this layered security model provides security zones as represented by the SoC platform 110 (e.g., an x86 instruction set architecture SoC, although other types of instruction set architectures can be used). At the lowest layer is the processing circuitry of the SoC platform 110. At a higher layer is an attack detection and response system (ADRE), implemented in an FPGA 120. At an even higher layer, is an attestation verifier service, ADRE Attestation Verifier Service (AAVS) implemented in an ASIC 130. Another possible implementation is for the AAVS to be in a specialized ASIC which monitors the FPGA/ASIC itself actively, as discussed in more detail below. Further, in some examples, the AAVS may be a network accessible Cloud/Edge service.

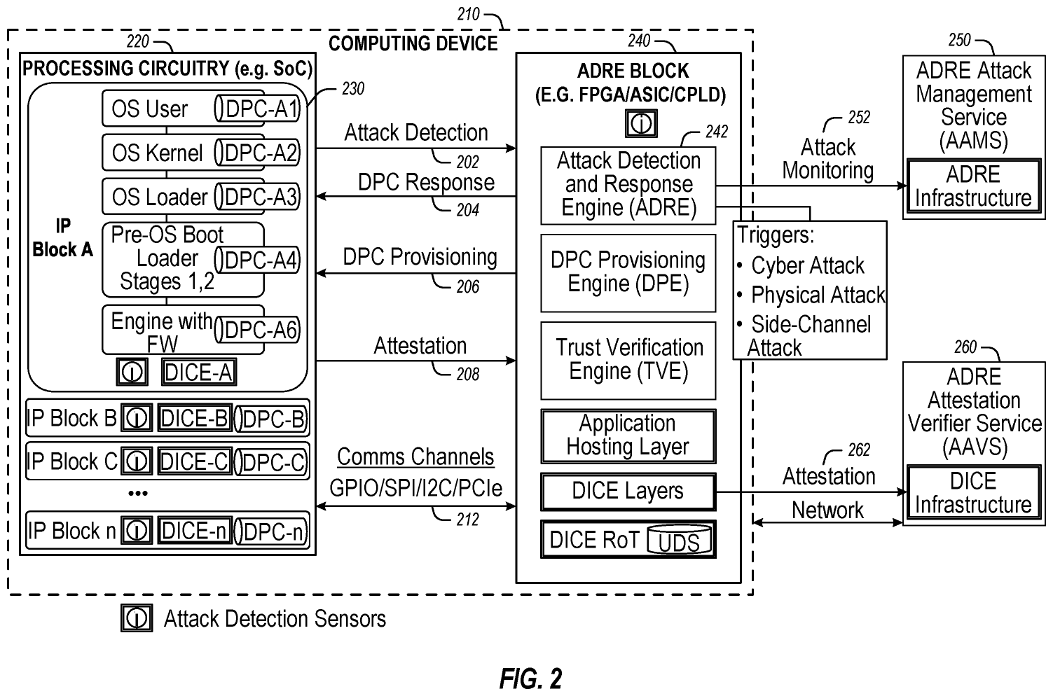

In an example, a periodic runtime attestation from a FPGA/ASIC to the AAVS is used to detect an attack at the embedded ADRE (Attack detection and response engine) subsystem. More details on the relationship between the AAVS and the ADRE are provided with reference to FIGS. 2 to 5, discussed below.

FIG. 2 depicts a system overview, identifying a layered physical attack detection and response system. In this system, tamper detection logic is integrated into an embedded ADRE subsystem/block 240 (e.g., a FPGA/ASIC/CPLD) that monitors a subject processing circuitry (e.g., an SoC) for cyber-physical attack events. Within the processing circuitry 220, an IP block 230 is configured to provide operational features for the user (e.g., the workload), the kernel (e.g., runtime environment, software stack, container runtime, virtual machine (VM) runtime), a loader, a bootstrap abstraction (e.g., in the OS or in the lower hardware), a feature for initializing the trustworthiness in the environment, and hardware/firmware that layers down into a hardware RoT.

The ADRE-observed system is instrumented with attack detection and response logic applied at various hardware layers. For example, IP Blocks (e.g., IP block 230) may be instrumented with DPC response capabilities that may trigger a focused response—such as removal of TEE protecting cryptographic keys before a physical attack on the TEE can be completed. (Normally, non-transient user keys are escrowed to ensure access to cipher texts; authentication keys may require re-enrollment).

The DPC may be pre-provisioned hardware and firmware that is invoked by a notification message. While FIG. 2 shows an ADRE block 240 with possible FPGA/ASIC/CPLD based implementations, alternative implementations may use embedded sequestered nanocores that run an embedded-software-based logical DPC with immutable code subsequent to being provisioned (e.g., security and manageability (S3M), Platform Firmware Resilience (PFR), embedded Secure Element (eSE)). These environments are less likely to be compromised during physical intrusions.

The ADRE block 240 is isolated from the one or more IP blocks of the processing circuitry 220 (SoC). In an example, the SoC and ADRE blocks each contain attack/tamper detection sensing and processing elements to help detect attacks on the SoC or ADRE IP blocks. The ADRE IP block 240 contains an Attack Detection and Response Engine 242 (ADRE) that monitors attack detection sensors and determines when the processing circuitry 220 (SoC) or the ADRE block 240 itself is under attack.

In an example, the ADRE block 240 operates the ADRE 242 to detect and send a DPC “digital poison capsule” response notification (e.g., DPC response 204) when an attack occurs in the processing circuitry 220 (e.g., detected in response to attack detection data 202 provided by the processing circuitry 220). Attack detection may trigger the transmission of one or more DPC messages as a DPC response 204. A DPC response message (e.g., a notification message) may be transmitted as a high priority message on an existing communications channel 212 such as GPIO/SPI/I2C/PCIe or may be transmitted over an ephemeral secure IPC channel.

The DPC response 204 is a message sent from the ADRE block 240 to the SoC/IP Block affected by the attack (e.g., IP block 230). For instance, there may be a DPC listener process on the IP Block 230/processing circuitry 220 (SoC) and in system software (not shown) that receives a DPC notification and invokes the DPC lockdown logic.

Each IP Block may be constructed using a hardware Root of Trust (RoT) (e.g., according to technologies such as Device Identity Composition Engine (DICE), Trusted Platform Module (TPM), Intel S3M, Intel ESE, Google Titan, Microsoft Proton, etc.) that underpins a secure layering of ROM, and firmware within an IP Block. Each IP Block also may implement an attestable identity with cryptographic keys that, when used, provides attestation proof of the IP Block trust and layered trusted computing base (TCB) trust.

One or more of the layers may execute software/firmware to monitor the attack detection sensors and to process/execute the DPC response 204. The layering and attestation sub-system, provided by DPC provisioning 206 and ongoing attestation 208, ensures that an operational integrity of the attack detection and response sub-system is preserved. Based on these layered principles, if the device can be booted securely and can verify through attestation it has been booted securely, then an attack detection and response system can monitor the environment to determine if the state has changed or whether some sort of attack is occurring. Such monitoring is performed using ADRE block 240, and the runtime component (the ADRE 242). Attack monitoring information 252 collected by the ADRE block 240 or the ADRE 242 may also be provided to an ADRE attack management service (AAMS) 250, which oversees a larger set of ADRE infrastructure for a system with additional computing devices.

Additionally, the evaluation of hardware and operational layers may be helpful to implement a response mechanism at an appropriate layer. For instance, a response could involve latching of hardware capabilities in order to apply a correct DPC response mechanism at a particular layer only (e.g., not needing to reset all the hardware in a computing system). Attestation may also be implemented on a layer-by-layer basis. For instance, attestation verification may be provided as attestation information 262 to a network-connected ADRE attestation verifier service 260, which oversees a larger set of DICE infrastructure for a system with additional computing devices.

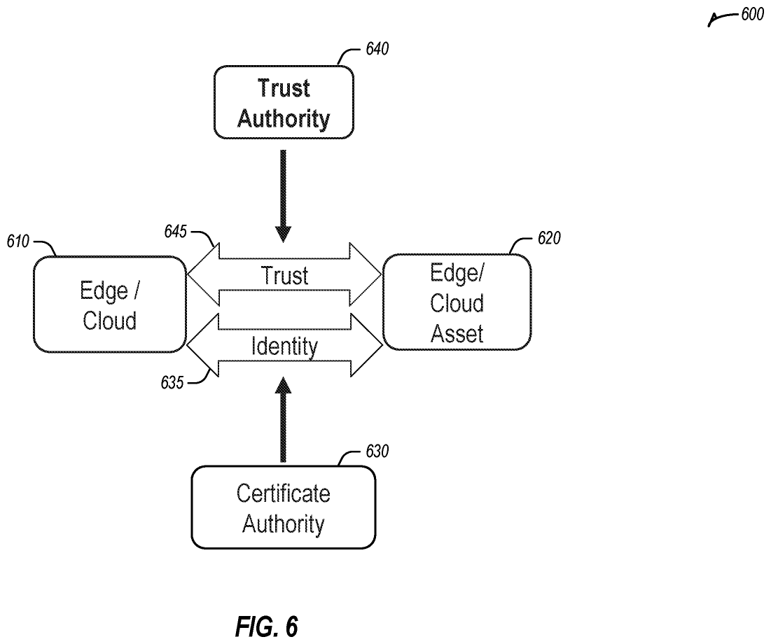

Various approaches of attestation-as-a service may be integrated to perform the attestation (e.g., discussed with operation 302, or coordinated with attestation operations 208, 262). Use of an external trust service (e.g., in an attestation-as-a-service or trust-as-a-service setting) provides an example of a service which can provide an AAVS. Such services are discussed in more details in FIGS. 6 to 10 below. It will be understood that such external trust services may take on additional capabilities discussed herein such as attack capabilities or service monitoring (e.g., via onboard attestation and attack management services).

FIG. 2 depicts a specific example which implements DICE with a DICE hardware root of trust, but other examples may utilize DICE layering without a DICE root of trust. For example, TEE technologies (e.g., Intel® SGX and TDX) can be adapted to support a DICE-like layering model. For each layer, there is some way for the system the trusted system is performing attestation and can attest. Further, DICE is one possible root of trust technology that supports immutable and attestable device identity, but other approaches may be used or integrated into the ADRE block 240 or processing circuitry 220. DICE is specifically shown to illustrate how a system with immutable and attestable identity can be used to improve tamper detection and response mechanisms.

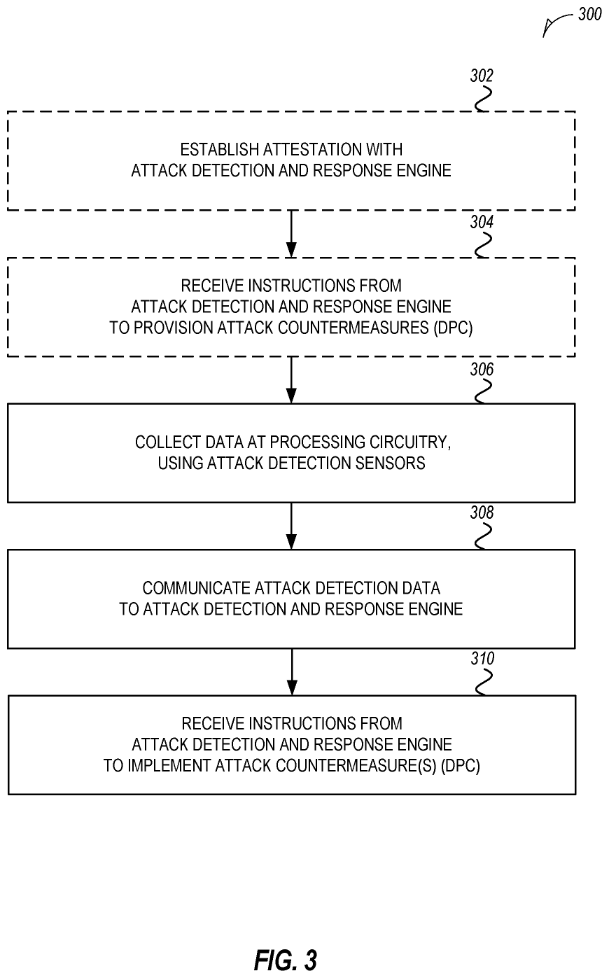

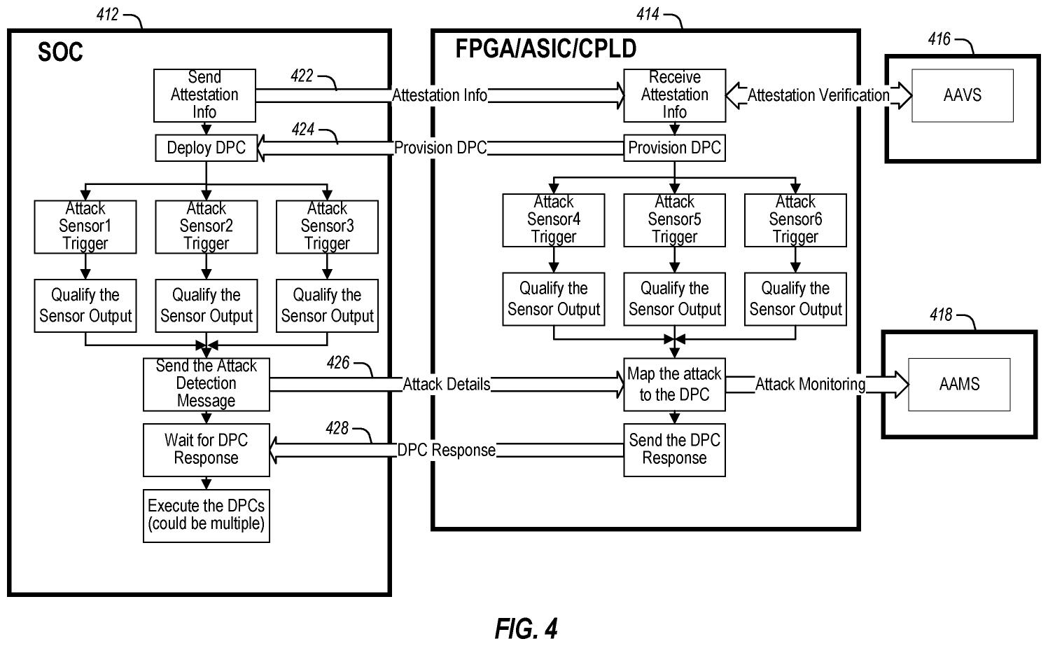

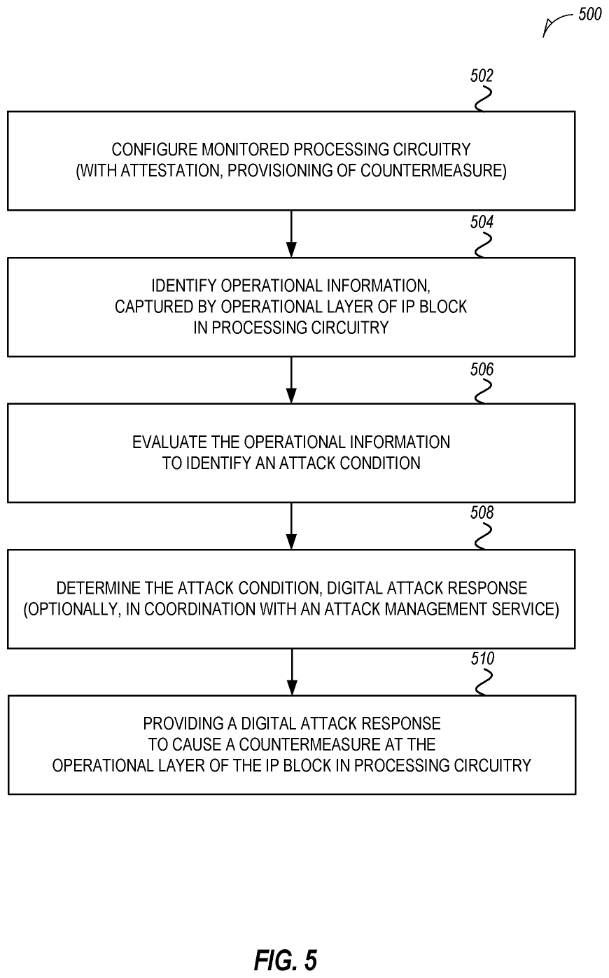

FIG. 3 depicts a flowchart 300 of a method for enabling an attack detection and response operations at processing circuitry which performs workloads (e.g., processing circuitry 220 (SoC) discussed above). Here, this flowchart 300 emphasizes two aspects. First, a computing device can boot processing circuitry securely, and can verify through attestation that the processing circuitry is booted securely. Second, a computing system can monitor the environment to determine if the state has changed or some sort of attack that is being performed or attempted. Such monitoring is enabled by having operational parts of the system be responsible for checking the other parts of the system (in terms of doing attestation and performing attack detection). The following flowchart 300 is thus described from the perspective of the processing circuitry. Operations performed at the ADRE are discussed below with reference to FIGS. 4 and 5.

At operation 302, the processing circuitry (e.g., processing circuitry 220) establishes attestation with an attack detection and response engine (e.g., ADRE 242). This operation may correspond to the attestation information 208 and attestation verification operations discussed above. Such attestation may be provided as a one-time pre-condition, or repeated at regular intervals.

At operation 304, the processing circuitry receives instructions from the attack detection and response engine to provision attack countermeasures (e.g., one or more DPCs). This operation may correspond to the DPC provisioning information 206 and DPC configuration discussed above. Such configuration also may be provided as a one-time pre-condition, or repeated at regular intervals.

At operation 306, the processing circuitry collects monitoring data, using attack detection sensors. This operation may correspond to the collection and use attack detection sensors at one or more IP blocks within the processing circuitry to obtain the monitoring data. This monitoring data may be processed (evaluated, filtered, classified) in part at the processing circuitry, or may be provided to the ADRE without processing.

At operation 308, the processing circuitry communicates attack detection data to the attack detection and response engine. This operation may correspond to the communication of attack detection data 202 provided to the ADRE 242. The ADRE 242, in response, can recognize one or more attack triggers or conditions from such data, including with the use of an AAMS 250 discussed above.

At operation 310, the processing circuitry receives instructions from attack detection and response engine to implement attack countermeasure(s), such as the one or more DPCs which have been provisioned. This operation may correspond to the communication of a DPC response 204 or corresponding messages or commands.

In other examples, some of the services for cyber and physical protections may be onboarded onto the device itself in an isolated execution environment (FPGA/ASIC/CPLD layer), or coordinated with an attestation verification within the on premises system. Such a setting may be useful for edge applications where there is a need for protection but network connectivity is not available (or, the device has not yet been provisioned yet).

As described earlier, attacks may be motivated with a goal to steal secrets and use them, so the present approaches provide a mechanism to thwart this consequence. However, other harms from physical and cyber attacks are addressed, by slight variations of detecting and responding to attacks involving secrets-stealing or reverse-engineering. Consider an attacker that only seeks to cause damage by corrupting data. This requires the ability to modify something; and can be prevented, once an intrusion or tampering attempt has been detected or is suspected. For example, once detected, an ADRE may cause all ability to modify data can be shutoff or disabled. For instance, modification capability may be disabled for all entities except as enabled only for writes that issue from AAMS and/or ADRE. All other agents redirect their writes through the AAMS/ADRE components during such a “suspected-attack” phase; and only after the AAMS/ADRE determine that it was a false warning, they return to normal operating mode.

Also consider an attacker that seeks to hijack the system itself (not merely steal and reuse secrets); such an attacker may be defeated as follows. The ADRE/AAMS components can periodically force the highest layer services in an edge machine to prove their authenticity by using challenge-response verification process. The process is lightweight for genuine (uncompromised) services, but is very cumbersome for an imposter that has gained undue access only for a time. Failure to revalidate within a short time causes a compromised process or device to be suspended, and a compromised platform executable (such as an OS or a driver) to be replaced by a randomly reseeded, original copy of the executable, through the agency of an ADRE-based component. This leaves such an attacker with very little room to continue with any meaningful use of the targeted machine.

Beyond prevention, the consequence of an attack—the theft and reuse data or secrets—remains the main threat to be defeated. Accordingly, many of the following paragraphs focus on thwarting this theft-and-use-secrets/data attack. The attacks that are detectable, and elements such as sensors used to detect such attacks, any unique algorithms, and complimentary approaches that lockdown the secrets, are listed below for a number of scenarios.

Attack Detection Details

The following provides non-limiting examples of types of attacks that are detectable.
1) Physical intrusion: Cameras or other physical security sensors connected to an IoT network are bridged with premises security monitoring service (e.g. AAMS).
2) Chip extraction: Chassis sensors detect access to logic boards, peripherals, blades and rackscale interconnect lines. The Chassis sensors are connected to a IoT network that may be monitored by an AAMS.
3) Chip top layer scraping: Physical unclonable functions (PUFs) or similar technology may be integrated into logic boards, SoCs, MCPs and discrete chips.
4) Clock glitching.
5) Under/over voltage attacks.
6) JTAG debug port access: An In-circuit Emulator (ICE) could be plugged to attempt accessing the sensitive registers for read/write.
7) A PCIe bus analyzer could be plugged in to act as a Bus controller (master) and arbitrarily DMA to/from DRAM.

The following provides non-limiting examples of types of detection sensors or other technology which may be used to detect the attack.
1) Tamper sensors that detect when the chassis is opened, when there is a relative movement between chassis components, etc.
2) JTAG traffic monitoring.
3) SPI/I2C Bus monitoring.
4) PCIe bus monitoring, e.g., to monitor the PCIe bus transactions for out of range accesses.

The following also provides non-limiting examples of detection algorithms. These may include algorithms which analyze the sensor data to conclude there really is an attack (and determine or handle false positives).
1) When traces of traffic to enumerate the JTAG are detected at runtime.
2) Unusual SPI location access (temporal and spatial anomalies).
3) Abnormal event counts—such as impractically high cache misses, branch prediction misses, protection faults, validity faults, to detect software based attacks.

In addition to these examples, response mechanisms can be used to signal the layer(s) beneath the layer at which the tamper detection was observed. This can ensure responses are processed before attacker is able to access any valuable assets.

The following table identifies possible attacks, detection methods, and responses, according to these examples. These are contrasted with mitigation approaches conventionally applied for such attacks.

| Detectable | | | Mitigation/Detection |
|---|---|---|---|
| Attacks | Detection Elements | Detection Algorithms | Approaches |
| Physical | Tamper | Sampling/Monitoring | Chassis |
| intrusion | sensors that | a GPIO or a strap for | accelerometers, |
| | detect when | state change or an | induction loops or |
| | the chassis is | System Management | ambient noise/light/ |
| | opened, etc. | Interrupt (e.g., | temperature sensors. |
| | | interrupt that is | AI/ML/DL trained |
| | | managed at a system | power models detect |
| | | level, higher priority | abnormal sensor |
| | | and usually unmaskable) | phenomena |
| | | or an Non Maskable | |
| | | Interrupt (e.g., an | |
| | | interrupt driven by | |
| | | hardware, that cannot | |
| | | be ignored.) | |
| Chip | Straps that | Sampling/Monitoring | PUFs or Thermite |
| Extraction | track the PCB | straps for state | Charges |
| | solder joints | change. | |
| | or traces or Vias | | |
| Chip top layer | Volume | Use of Volume | PUFs or Thermite |
| scraping or | protections, | protection elements | Charges |
| de-lid | sensor or | to establish unique | Clear memory on |
| | other elements | key material to | tamper event |
| | | derive keys | detection |
| Clock | Glitch | Monitor Active and | AI/ML/DL trained |
| Glitching | detection | Passive timing | power models detect |
| | circuitry aka | spikes. | abnormal clock |
| | Tamper | Use of frequency | phenomena. |
| | Resistant | tolerances as | (Note: Hammock |
| | Clock | qualifier for key | Harbor clock |
| | | release. | synchronization |
| | | | technology can be |
| | | | used to compare local |
| | | | time to peer nodes in |
| | | | cases a clock chip |
| | | | tampering results in |
| | | | skewed time.) |
| Under/over | Voltage | Sample | AI/ML/DL trained |
| voltage | levelers, | undocumented bits | power models detect |
| | “Chicken” | along with Fuses in | abnormal electrical |
| | bits (e.g., un- | early FW or Pre-OS | and/or |
| | documented | bootloader. | electromagnetic |
| | bits used to | Use of voltage | phenomena |
| | disable | tolerances as | |
| | functional | qualifier for key | |
| | security | release. | |
| | features in | | |
| | order to | | |
| | isolate or | | |
| | identify faults) | | |
| JTAG ports | JTAG traffic | Temporal Access to | AI/ML/DL trained |
| | monitoring | TAP enumeration. | power models detect |
| | | Boot vs. runtime, etc. | abnormal JTAG use, |
| | | | overrides on factory |
| | | | settings (that disable |
| | | | JTAG ports) etc. . . . |
| SPI/I2C low | SPI/I2C bus | Temporal and Spatial | AI/ML/DL trained |
| speed bus | monitoring | anomaly detection. | power models detect |
| spoofing/ | | | abnormal bus traffic, |
| tamper | | | drain on pull up |
| | | | resistors, etc. . . . |
| PCIe DMA | PCIe bus | Monitor the PCIe bus | AI/ML/DL trained |
| bus Mastering | monitoring | transactions for out | power models detect |
| for DRAM | | of range accesses | abnormal bus traffic, |
| spoof | | | drain on pull up |
| | | | resistors, etc. . . . |
| Over/under | Temperature | Important to monitor | AI/ML/DL trained |
| temperature | sensors/ | temperature anomalies. | power models detect |
| | Thermal trips | Use of current | abnormal thermal |
| | | monitoring features | phenomena |
| | | to repurpose as AT | |
| | | sensors | |
| SC: SPA/DPA | Power glitch | Key rolling | AI/ML/DL trained |
| Simple Power | detection | techniques | power models detect |
| Analysis and | | Use of sensor for | abnormal electrical |
| Differential | | capacitive changes | phenomena |
| Power | | when being probed | |
| Analysis (e.g., | | Create EMI (RF) | |
| techniques used to | | sensors for an EMI | |
| conduct an attack | | attack to extract keys | |
| typically to | | | |
| extract crypto | | | |
| keys) | | | |
| Die Analysis | Detection of | Use of sensor for | PUFs |
| via Focused | FIB via a | capacitive changes | |
| Ion Beams | sensory input | when being probed | |
| (FIB) | | or stress changes on | |
| | | silicon when being | |
| | | delayered or thinned | |
| | | Use of sensory | |
| | | material to detect | |
| | | energy from | |
| | | scanning equipment | |
| | | such as magnetic | |
| | | fields when a FIB is | |
| | | used. Include critical | |
| | | signals as part of | |
| | | scan chain used to | |
| | | cryptographically | |
| | | derive keys. | |
| Scanning | Image | Use of material to | PUFs |
| Electron | detection | create opacity within | |
| Microscope | | silicon | |
| (SEM) | | | |

The following provides non-limiting types of attack response activities.

Least Intrusive Responses: Erase memory; Clamp clock to very low frequency (slow down possible attacker, frustrate attack); Disable port access; Halt processor.

Devious/Misdirecting Responses: Substitute secrets with dummy secrets; Activate Honeypots (mislead an attacker by simulating correct functioning of the system, so if the attacker uses the stolen (dummy) secret, they can be traced).

Firewalling/Sequestering Responses: For a software based intrusion (e.g., altering correct instructions with compromised instructions), respond by sandboxing the affected cores, memory ranges, etc. so that the attacker's ability to gain more control or observability is curtailed.

Most intrusive (e.g., Crypto lockdown) responses: Disable key derivations; Disable read/write (RW) access to Fuses; Disable HW Crypto operations (e.g., Disable Sign/Verify and Disable Encrypt/Decrypt); Delete Key encryption keys (KEK) and keys on all relevant storage media (Flash, Hard disk, DRAM); Disable Key ladders.

Destructive responses: Thermite, or destructive electromechanical mechanisms.

Any of these responses may be coordinated with the use of a DPC notification. In an example, a DPC notification message is transmitted by each layer to the layer above it via IPC and each layer implements a listener running at high priority (non-preemptible) to intercept and process the DPC. The DPC could also specify the timeframe to lockdown to make it more useful—{IMMEDIATE, AFTER_SOME_TIME, NEXT_BOOT}. To support this cascading DPC across the stack, the OS modules may implement an out-of-band process for notifying the various hardware or operational layers of the platform (e.g., lower layers of the IP block 230 depicted in FIG. 2).

An FPGA, in addition to locally detecting the attack, could also retrieve the threat/attack information from the cloud verifier and then trigger the DPC. Further, the DPC could also be transmitted by the IA SoC when it detects the cyberattacks or cyber-physical attacks. This makes the MCP more robust since both IA SoC and FPGA/ASIC are both capable of detecting different threats and able to trigger the lockdown of the secrets to prevent exposure to attackers who are after reverse engineering.

Finally, it will be understood that a DPC could be transmitted via a dedicated HW entity. This HW entity could exist within the CPU complex and provide the secure communication channel between FPGA/ASIC and CPU as described herein.

Attestation and Trust Verification Details

In an example, an attestation sub-system provides DICE RoT hardware that is integrated into the IP Block. A DICE engine contains a Unique Device Secret (UDS) that is unique to the IP Block such that each IP Block can generate a unique attestable identity. DICE layering is a method whereby a RoT provides a unique value called a Composite Device Identity (CDI) to a firmware or software layer that executes next (following the RoT or a previous DICE layer). Each DICE layer has a unique CDI based on the expectation that a hash of the firmware for the subsequent layer is used to compute the next CDI value in addition with the CDI or UDS value from the previous layer or RoT. Each layer may generate a unique attestable identity or may only supply a CDI to the next layer. At least one DICE layer will generate an attestable identity that is used to attest the entire DICE layer to the RoT.

In an example, each IP Block may attest its IP block operational state/status to the Trust Verification Engine (TVE) running in the ADRE Block. The TVE ensures that all participating IP Blocks of the SoC are operationally correct. This may be accomplished by polling each IP block's DICE Identity and evaluating the attestation messages it receives. Alternatively, the IP block Attester process delivers an attestation message periodically and proactively to the TVE. In this scenario, the TVE may anticipate receiving an attestation message at regular intervals. If a message is not received it may regard the omission as a possible attack scenario and notify the ADRE.

The TVE may also interact with an external AAVS that is a Cloud/Edge service that accepts attestation messages regarding the ADRE Block. The ADRE Block architecture is similar to the other SoC blocks in that it contains a RoT and attestable identity. A DICE layering architecture is used to ensure proper function of the ADRE, TVE, and DPC provisioning engine (DPE) components. The AAVS may poll or accept periodic attestations from the TVE. The AAVS ensures that the ADRE block is operating properly.

In an example, the TVE may be the second to the top-most layer in the ADRE Block and the ADRE and DPE may be peer functions operating at the top-most layer. This configuration ensures the TVE can generate an attestation identifier and keys that can attest to the integrity of the ADRE and DPE. Other sound configurations are possible as well as unsound configurations. The AAVS ensures the ADRE Block boots to a sound configuration.

FIG. 4 depicts detection and response flows in various hardware for detecting attack conditions and implementing cyber-physical protections. This specifically depicts flows occurring in processing circuitry 412 (an SoC), and a corresponding attack detection and response circuitry 414 (e.g., an ADRE block implemented as a FPGA/ASIC/CPLD).

A first operation shows the coordination of attestation information 422, provided from the processing circuitry 412 to the attack detection and response circuitry 414. The attestation verification may be further coordinated with a use of an AAVS 416 as discussed above.

A second operation shows the coordination of provisioning and deploying the DPC, based on DPC provisioning information 424 provided from the attack detection and response circuitry 414 to the processing circuitry 412.

A third and fourth operation shows the identification of attack sensor triggers (among sensors 1, 2, and 3 at processing circuitry 412, and among sensors 4, 5, 6 at the attack detection and response circuitry 414), and the qualification of this sensor output at the respective circuitry.

A fifth operation shows the communication of an attack detection message, and attack information 426, from the processing circuitry 412 to the attack detection and response circuitry 414. This causes the attack detection and response circuitry 414 to map the attack to a particular countermeasure (provided by the DPC). The identification and mapping of the attack to a particular countermeasure may be coordinated with use of an AAMS 418 as discussed above.

A sixth operation shows the communication of an attack response message, provided as a DPC response 428 from the attack detection and response circuitry 414 to the processing circuitry 412.

A seventh operation shows the implementation of the countermeasures at the processing circuitry 412, such as with the execution of one or more DPCs.

It will be understood that the components illustrated in the diagrams of FIGS. 2 and 4 are provided for purposes of illustration, and that other types of components or hardware may be used. For example, FPGAs may include hardened root of trust with attestable device ID and attestation of customer supplied designs which could operate as an ADRE block. Processor cores can be equipped with roots of trust (e.g., security and manageability (S3M) or Platform Firmware Resilience (PFR) resources) that enable hardened launch of FW and SW stacks. The FW and SW stacks enabled for hardened launch could contain a digital poison pill provisioning engine, or DPE, functionality.

Other features and hardware may also be integrated into or modified for the approaches discussed above. As an example, an S3M in a CPU (or XPU) can replace or augment the use of secure enclaves (e.g., SGX/TDX Platform Service Enclaves), to enable enclaves and trust domains that host DPE functionality in a TD or TPA module. The various communication channels may rely on TDX-IO, SPDM or other secure comms that support attestation of the digital poison capsule agent (DPA) nodes. Further, they can represent this state to a remote TaaS. Subsequently, once the DPA nodes are determined to be working properly, the nodes can be configured as a sensing network to report tampering to an attack management service.

Based on the preceding configurations, various operations may be used to implement or operate the features of the ADRE. FIG. 5 depicts a flowchart 500 of an example method for implementing a cyber-physical protection in an edge computing platform, from the perspective of an ADRE. Consistent with the examples above, processing circuitry of the edge computing platform to be monitored may be provided in a System-on-Chip device, and attack detection and response circuitry that monitors this processing circuitry with the ADRE may be provided in a configured field programmable gate array (FPGA), Application Specific Integrated Circuit (ASIC), or Complex Programmable Logic Device (CPLD). Other hardware configurations are possible, including with the use of one or more central processing unit (CPU) processor, graphics processing unit (GPU) processor, or network processor to provide the processing circuitry (e.g., operating as compute circuitry).

At 502, operations are performed to configure or initialize processing circuitry for cyber-physical attack protections and mitigations. The processing circuitry may perform compute operations with the use of multiple layers of an IP block of the processing circuitry, such as in the configuration discussed with reference to FIG. 2, above. The attack protections and mitigations may be launched to: respond to a single type of attack (or attack condition) with a single type of mitigation; respond to a single type of attack (or attack condition) with multiple mitigations (e.g., more than one DPC); respond to multiple types of attacks with a single mitigation; or respond to multiple types of attacks with multiple mitigations.

The configuration or initialization for attack protections and mitigations may include attestation of the multiple layers and the IP block, and provisioning of one or more attack countermeasures. For example, trust of the IP block can be established based on attestation of a hardware root of trust (RoT) at a lower layer of the multiple layers of the IP block. Attestation of the IP block may be performed based on the attestation of the multiple layers including the operational layer of the IP block, such as with attestation of the multiple layers of the IP block that is established according to a Device Identifier Composition Engine (DICE) attestation architecture. Further, the attestation of the hardware RoT may be based on attestation according to the DICE attestation architecture.

The provisioning of the one or more attack countermeasures at the IP block may include operations that enable a particular countermeasure (or, multiple countermeasures) to be deployed in the IP block (e.g., at an operational layer of the multiple layers (or in some examples, at more than one of the multiple layers). In some examples, this provisioning is performed provided at an earlier time, such that the processing circuitry is provided to the computing platform in a pre-provisioned state. In other examples, this provisioning is provided with the use of an attack detection and response system or, more specifically, attack detection and response circuitry and engine in the edge computing platform (e.g., in an ADRE block discussed with reference to FIG. 2, above). Once the attestation and provisioning operations are completed (prior to an attack condition), the relevant attack condition can be identified and responded to as discussed in the following operations.

At 504, operations are performed to identify (e.g., retrieve, obtain, receive, filter) operational information (data), that is captured by monitoring at least one operational layer of the multiple layers of the IP block. In an example, the operational information received from the processing circuitry includes (or is provided by) an attack detect message generated by the processing circuitry. This attack detect message may include data from at least one attack detection sensor at the processing circuitry. In various examples (consistent with the examples discussed in more details above), the computing operations that are performed by the processing circuitry include execution of a workload in a trusted execution environment. Accordingly, operational data may be provided by at least one attack detection sensor that is provided by or located at one or more of: a tamper sensor; a traffic monitoring sensor; or a bus monitoring sensor. Such sensors may be deployed at one or multiple layers of the processing circuitry; thus, operational data include sensor data from one or multiple layers (and, one or multiple sensors).

At 506, operations are performed to evaluate the operational information to identify an attack condition. The identification of the attack condition may be based on at least one detection algorithm that analyzes the operational information (data) obtained from the processing circuitry. In one example, multiple (a plurality of) operational layers are monitored and used to perform the countermeasure. In another example, only one operational layer used to implement the countermeasure.

At 508, operations are performed to determine the attack condition and digital attack response (optionally, in coordination with an attack management service). In various examples (consistent with the examples discussed in more details above), the attack condition is identified as a cyber attack, a physical attack, or a side-channel attack. In some examples, multiple attack conditions, or multiple characteristics of a single attack, may be identified.

At operation 510, operations are performed to provide a digital attack response, that cause (e.g., launch, initiate, control) an appropriate countermeasure (and optionally, multiple countermeasures) at the operational layer of the IP block in the processing circuitry. For instance, the countermeasure may include at least one of: erasing memory; disabling access; halting processor operations; sandboxing; data substitution; activation of a honeypot; or a cryptographic lockdown. Other countermeasures and resulting operations are discussed above.

Additional operations may be performed at or by the attack detection and response engine and the attack detection and response circuitry that operates such an engine. For instance, the attack detection and response circuitry may include a plurality of operational layers, and the attack detection and response circuitry provides attestation of its plurality of operational layers to an attestation verifier service operated by another computing device. Also, in an example, the operational data from the processing circuitry is communicated from the attack detection and response circuitry to an attack management service operated by another computing device, as the attack management service coordinates with the attack detection and response circuitry (e.g., at 508) to identify the attack condition and identify an appropriate countermeasure.

The operations discussed above may be integrated with a variety of network services for attesting, monitoring, and responding to cyber-physical threats, particularly in edge computing deployments. The following services provide more examples of attestation verification and a “TaaS” Trust as a Service system that could become an integral part of an ADRE. However, it will be understood, that a TaaS or attestation system may be integrated in other forms as part of an overall ADRE deployment.

Trust and Attestation Service Overview

The following description (e.g., discussed with reference to FIGS. 6 to 10) includes an overview of confidential computing and the relevant context and use cases for trust verification and attestation servicing. Such verification is provided from a “trust authority” in an extensible SaaS (Software as a service) deployment, that provides verification of evidence for TEE, platform and device integrity. This SaaS deployment, referred to herein as “Trust-as-a-Service” (TaaS), deploys confidential computing technologies to offer trust verification in addition to other security techniques. For instance, this TaaS deployment may be configured to perform features of the AAVS, discussed above, including to provide attack identification and response, service monitoring, attestation, and identify verification capabilities.

Confidential computing technologies may be deployed, with the present techniques, to establish trust for a variety of entities and assets, in whatever form that such entities and assets are embodied. For instance, the following approaches describe a trust authority service, independent of cloud service providers (CSPs), which may provide attestation to verify workloads, computing assets, computing devices, and a variety of other assets or entities.

In current computing systems, most CSPs self-attest to the security and validity of CSP resources. This often reduces to a conflict-of-interest condition that reduces confidence in cloud-based workload automation for the respective cloud tenants, and complicates trust relationships in multi-cloud solutions. The following TaaS approach, if hosted by an independent provider, offers a deployment alternative to provide a trust infrastructure for assets and entities, and attests to the security of such assets and entities.

As used herein, a compute “asset” which is the subject of the attestation and trust verification may relate to any number or type of features or entities in or associated with a computing system. This may be, for instance, hardware, firmware, software, network operations, data, a data set, a particular instance of data (e.g., a workload) a particular instance of software (e.g., virtualized components), and similar designated or defined portions thereof.

Additionally, an asset that is subject to attestation and trust verification may be used, instantiated, accessed, or verified as part of system operation, management, administration, configuration, or other use cases. Thus, at a broad level, an asset that is subject to trust verification and attestation may be any “thing” in a computing environment that is observable by another entity. For instance, many of the following examples refer to the attestation of a workload as trusted, and performing some operation (e.g., executing the workload, unencrypting some data) as a result of successful attestation. Other use cases for access, retrieval, storage, or transmission of data may also be implemented, including in connection with the AAVS and cyber-physical protection approaches discussed above.

FIG. 6 depicts a simplified system overview for the use cases discussed herein, providing a comparison of trust and identify verification. As shown, the following SaaS implementation 600 of a Trust Authority (TA) 640 provides remote verification of the trustworthiness assertions for each asset 620 used with an edge/cloud deployment 610, including compute assets, based on use of attestation, policies and reputation/risk data. The following SaaS implementation of the TA 640 is operationally independent from the Cloud/Edge infrastructure provider that is hosting confidential compute customer workloads. Nevertheless, 640 may also be functionality embedded in a peer Edge/Cloud node 610 that may interact with an Edge/Cloud asset 620 or second Edge/Cloud node 610 and wishes to assess trustworthiness properties of the peer.

In this setting, the TA 640 is an entity that issues digital trust certifications (in the form of, for example, a JSON Web Token (JWT) token, CBOR Web Token (CWT), W3C Decentral Identity Token (DID), X.509 certificate, Kerberos Ticket or other secure digital certification structure), to establish trust verification procedures 645 between the edge/cloud 610 consumer and the edge/cloud asset 620. For instance, the digital certification can certify the trustworthiness of a particular compute asset used to execute a workload for the consumer.

The role of the TA 640 is similar to that of a certificate authority 630 (CA), such as for a CA that issues cryptographic digital certificates to establish identity verification procedures 635. In this role, the CA essentially operates as an “identity authority” with X.509 certificates, but there are other examples of identity authorities (e.g., a W3C DID issuer or a DID Blockchain). Further, the role of the TA 640 is to confirm the trust level or trustworthiness of the asset 620. As will be understood, proving trustworthiness is a function of three principles: (1) attestation—which includes verifying the identity of the asset; (2) policy—where a customer can indicate what policy needs to be verified as part of trust evaluation; and (3) reputation—which comes from situation analysis or repudiation data from a third party (and/or, from crowdsourced parties). Such “reputation” can refer to properties of a company, person, product, service or any other element or digital platform, and can be impacted by any number of content or actions provided by or with such an entity.

In an example, the TA 640 may be provided from an edge or cloud service implemented in a software as a service (SaaS) model. For instance, the TA 640 can be configured to issue digital trust certification on demand, only if the TA 640 successfully verifies the asset 620 (e.g., a compute asset) based on remote attestation operations, policy validation, and data such as reputation or risk assessment information.

In an example, the TA 640 is operationally independent from the cloud and edge infrastructure service provider that is hosting the confidential computing workloads. This enables delinking of the attestation provider and infrastructure provider.

The following examples refer to the use of a TA configured for verifying the trustworthiness of components using Intel® secure computing components, such as TEEs implemented with Intel® SGX and TDX technologies. However, the present approaches are also applicable to a variety of other TEEs and secure computing components from other manufacturers, such as AMD® SET and ARM® realms. Thus, it will be understood that the following approaches are not limited to deployments with Intel® or x86 technologies.

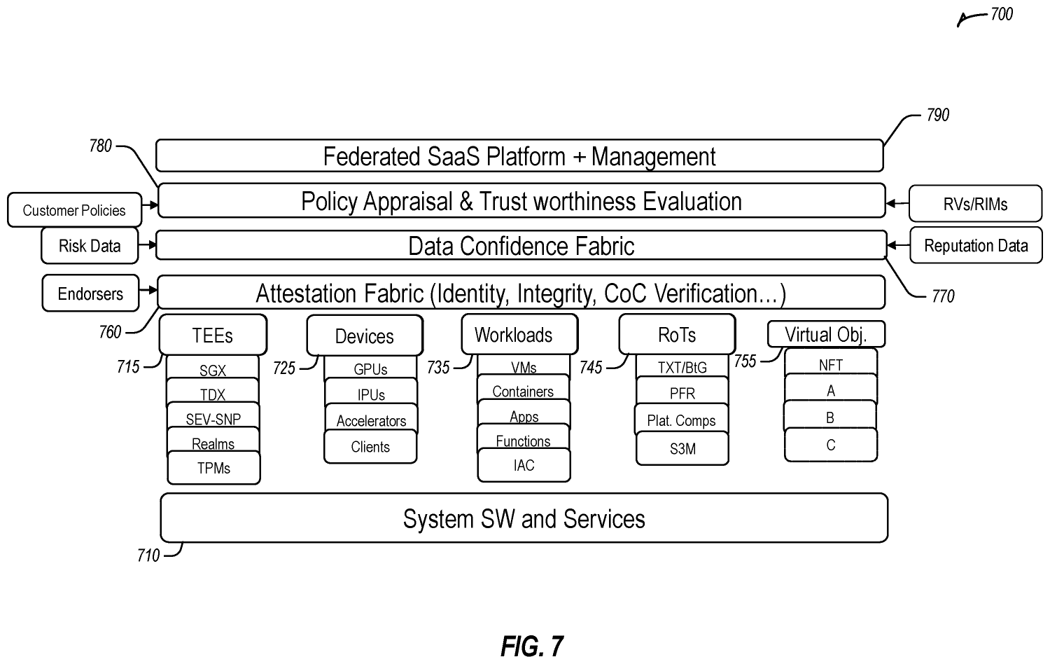

FIG. 7 illustrates hardware and functional components 200 used in connection with operations of a TA. This diagram specifically depicts a SaaS implementation of a TA that provides remote verification of the trust worthiness of a number of compute assets.

In these components 700, the attestation fabric 760 is the initial layer that provides verification of identity, which works in operation with the higher layers (data confidence fabric 770, policy appraisal & trustworthiness evaluation 780) which perform the reputation and appraisal of the customer policy. In addition to endorsers, other inputs to the attestation fabric 760 may include remote validation (RV) and reference integrity manifests (RIMs). Also, as discussed in the examples below, the SaaS platform may be configured for federated operation and management, using federation components 790.

As an example, the TA can support different types of attestation, based on what compute asset a user wants to verify. These may include attestation of the compute assets depicted in FIG. 7, such as:
Attestation of one or more Platform software components 710, which verifies the platform firmware, OS and other software while the host is booted.
Attestation of one or more TEEs 715. This includes the verification of a secure enclave (e.g., Intel® SGX enclave), trust domain-supported virtual machine (e.g., Intel® TDX VM), and other types of TEEs including AMD® SEV_SNP, and others.
Attestation of one or more devices 725. For instance, this may include verifying the firmware on different type of devices.
Attestation of Workloads 735, such as VMs, containers, apps, functions, etc.
Endorsement of one or more roots of trust 745 (e.g., “endorsed” by endorsers using a device ID credential to identify the RoT and its trustworthiness properties).
Attestation of one or more virtual objects 755, such as various non-fungible tokens (NFTs).

Users can define policies (customer policies) used to verify against these compute assets, with the policy appraisal and trustworthiness evaluation functions 780. The TA can also integrate the compute asset based on risk or reputation data, such as in the data confidence fabric 770.

Thus, with use of the framework depicted in FIG. 7, verification of trust of devices that connect to the platform can be provided including for infrastructure processing units (IPUs), GPUs, accelerators, and the like. Trustworthiness verification can also be provided for all types of workloads whether they are VMs, containers, since the integrity and identity of the workload are attested and verified as part of the trust authority. Likewise, Trustworthiness verification can be provided for ROTs, which are anchors on which the goodness of the platform is verified. Finally, trustworthiness verification may be provided for virtual objects such as non-fungible tokens (NFTs), including in scenarios where authenticity of ownership is verified during creation and transfer of an NFT.

Based on this configuration, a trustworthiness score can be generated provided as a signed token by the trust authority, so that customers can use the signed token to make decisions of their respective workloads. The SaaS platform provided intuitive experience to interface with the Trust Authority including third party management tools such as security information and event management (SIEM) tools.

It will be understood that other variations may be provided to the components 700 and layers depicted in FIG. 7 for a particular TaaS deployment, based on the different HW, specific devices, TEEs and different ROTs, in use. However, it will be understood that this architecture provides an extensible way for deploying trust verification of a variety of hardware, software, workloads, and data.

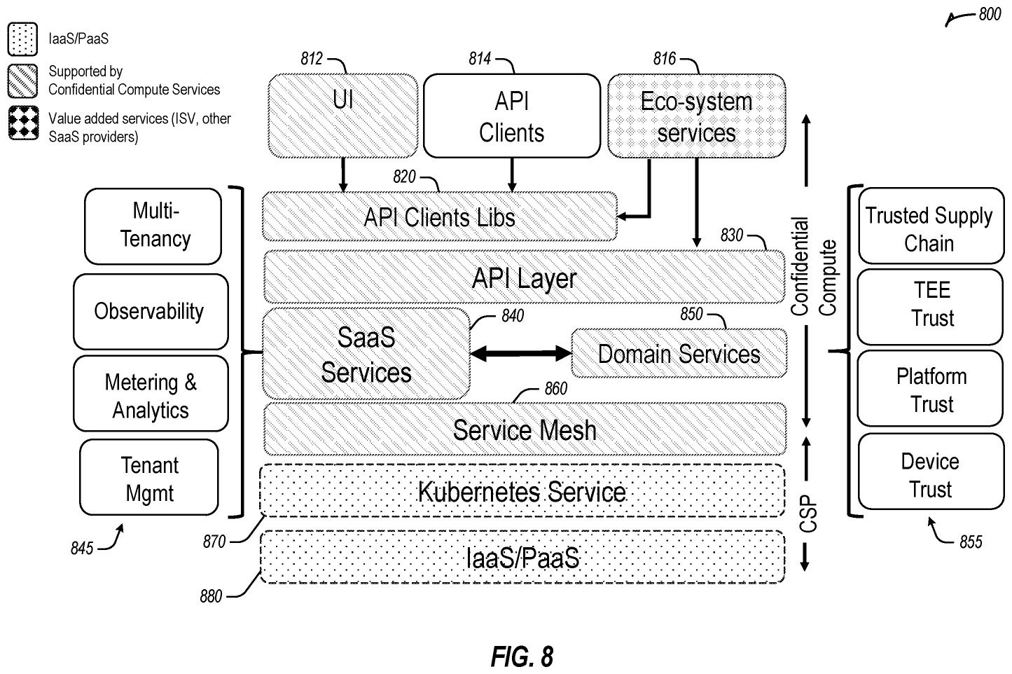

FIG. 8 depicts an example software stack 800 used in connection with trust verification services, for providing the presently disclosed TaaS architecture. As shown, the services here are built on top of standard containerized (e.g., Kubernetes, K8S services 870) which is offered by many service providers (e.g., an Infrastructure-as-a-Service/Platform-as-a-Service cloud or edge compute provider 880). This software stack is built with cloud native architecture with integration to a service mesh 860, so that many aspects of scale, security, load balancing are moved out of domain services into the service mesh 860. Accordingly, domain services (including business logic and infrastructure logic) can be moved to management by the service mesh 860.

In the software stack 800, typical software-as-a-service (SaaS) instances 840 and domain services 850 can be provided, which are coordinated with service operation features 845 (e.g., multi-tenancy, observability, metering and analytics, tenant management). Above these services, various layers of APIs (e.g., API layers 830, API client libraries 820) allow different parties to interface and consume the services (including with user interfaces 812, API clients 814, and eco-system services 816, and the like).

The TaaS architecture discussed herein may be extended to introduce trust from confidential compute technologies 855 into operations at any of layers 860, 850, 840, 830, 812, 814, 816. At a simplified level, this may include trust established with: a trusted supply chain; TEE trust; platform trust; and device trust.

As will be understood, different independent software vendors (ISVs) may wish to interface and provide value added services on top of the various TaaS APIs and features. This may be provided through a variety of observability, metrics, and analytics services. Thus, one possible deployment of TaaS is through the use of an ecosystem of service providers who can interface to the TaaS APIs, to obtain access to select data, as the TaaS provides value-added service (including coordinated operations and revenue events with ISVs).

A variety of use cases may be provided for the TaaS architecture and services discussed herein. These may include, for instance:
Enterprise User: Trust Verification prior to releasing keys to Confidential Compute workloads (AI Model Inference Demo).
ISVs: Privacy preserving Data Distribution (e.g., with encrypted messaging, or other apps and services which require end-to-end security).
Multi-party: Trusted Federated Machine Learning.

Cloud Service Providers: Trust Verification of
Telecommunications/communication service providers (CoSPs) Infrastructure for cloud service provider (CSP) use.

Blockchain: Node/Object verification before admitting to blockchain networks. For example, trust verification could be implemented at a client, server, or other entities wanting to become part of blockchain network. Consider a use case with a customer, requiring an entity has to have certain security properties before joining the blockchain network. The TaaS service discussed herein can provide security properties, while existing systems in the network validate the properties. Thus, if an entity is convinced a new actor is trusted and verified, the new actor can become a trusted part of the network.

NFT: Verification of trust when an entity is transferring ownership of an NFT or other virtual object from one entity to another. Before an entity takes ownership, the TaaS services discussed herein can be used to verify that a “chain of custody” exists from the original creator (original owner) to the current owner, who is verified. A verification of a “chain of custody” can be applied to other settings and use cases as well.

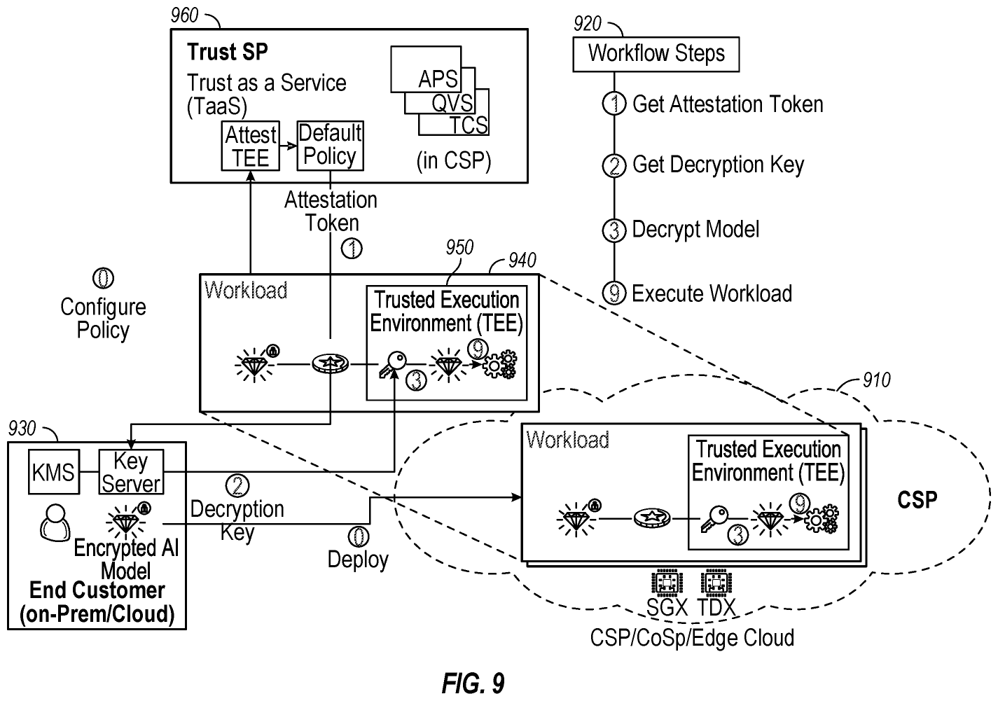

FIG. 9 illustrates a use case for trust verification for a key release procedure 900 at a cloud service provider (CSP) 910, according to an example. Here, the CSP 910 uses confidential computing technologies to securely perform a workflow 920 with trust verification. (Additionally, this example may be adapted to perform the attack detection and response operations, discussed above).

In an example, the CSP 910 may execute a workload 940 in a trusted execution environment 950, on behalf of an end customer 930. This workload 940 is executed after obtaining an attestation token from a TaaS instance at a trust service provider 960 (e.g., operating at another CSP).

In an example, the TaaS features may be implemented across services used in a service mesh architecture. For example, the following approaches for verification ensures that all the services that are part of a distributed software run in a TEE and are attested and verified before they can process end users' requests. Beside adjusting verification policies, no changes in the architecture of the solution are required to handle changes in the size of the distributed software, the number of instances per service and the interaction between the instances of the services. This allows the solution to scale and support very dynamic distributed software such as cloud native deployments.

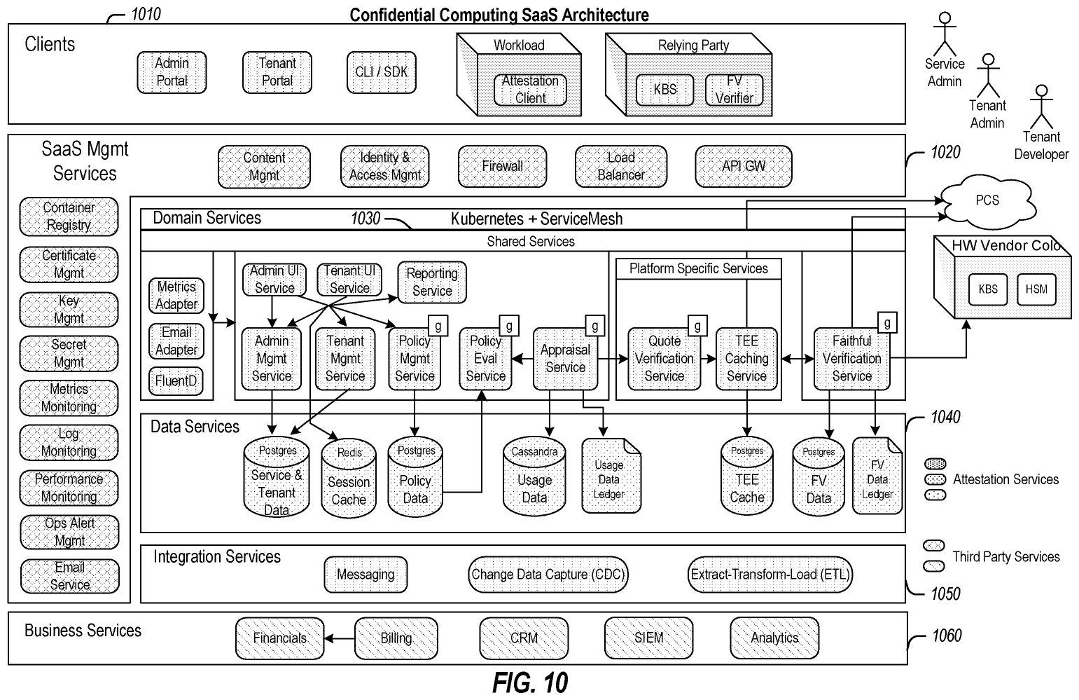

FIG. 10 illustrates an overview of an architecture 1000 for implementing TaaS features in a SaaS deployment. Here, a number of clients 1010 (workloads, relying parties, portals) are operated by users (e.g., such as one or more admins) to consume and operate the features of the SaaS deployment.

The SaaS deployment may include the following categories of services, operated by a third party or by an attestation service provider, to provide the TaaS features: management services 1020; domain services 1030 (including shared services for attestation); data services 1040; integration services 1050; and business services 1060. Additional or alternative services may also be used.

### Example Edge Computing Architectures

Although the previous discussion was provided with reference to specific networked compute deployments, it will be understood that the TaaS and ADRE instances may be implemented at any number of devices that access services from the “cloud”, devices that access services from the “edge cloud”, or devices that access services from the “data center cloud”.

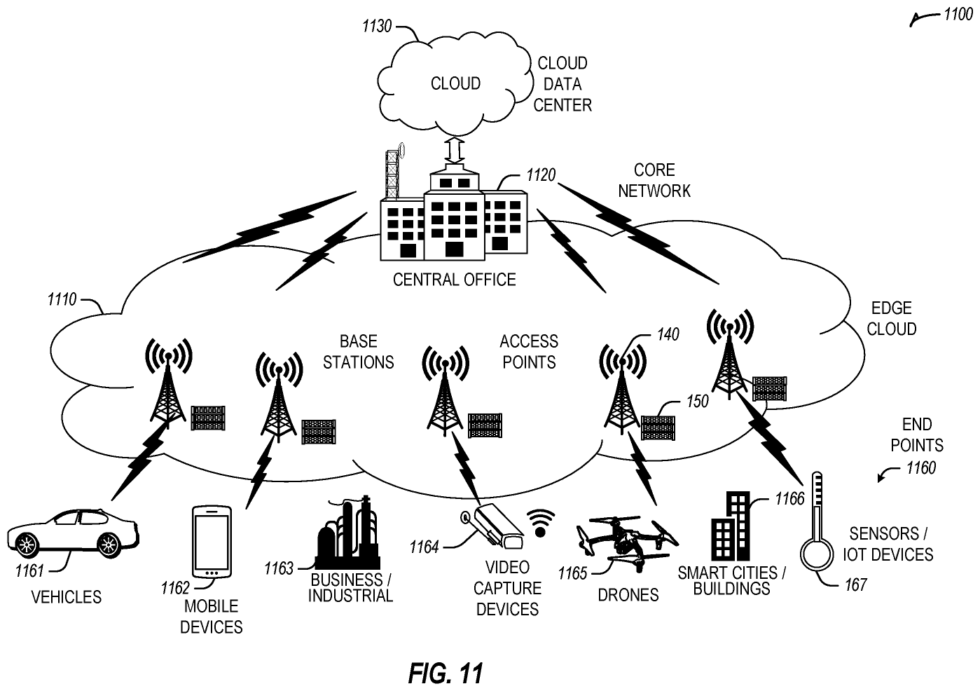

FIG. 11 is a block diagram 1100 showing an overview of a configuration for edge computing, which includes a layer of processing referenced in many of the current examples as an “edge cloud”. As shown, the edge cloud 1110 is co-located at an edge location, such as an access point or base station 1140, a local processing hub 1150, or a central office 1120, and thus may include multiple entities, devices, and equipment instances. The edge cloud 1110 is located much closer to the endpoint (consumer and producer) data sources 1160 (e.g., autonomous vehicles 1161, user equipment 1162, business and industrial equipment 1163, video capture devices 1164, drones 1165, smart cities and building devices 1166, sensors and IoT devices 1167, etc.) than the cloud data center 1130. Compute, memory, and storage resources which are offered at the edges in the edge cloud 1110 are critical to providing ultra-low latency response times for services and functions used by the endpoint data sources 1160 as well as reduce network backhaul traffic from the edge cloud 1110 toward cloud data center 1130 thus improving energy consumption and overall network usages among other benefits.

Compute, memory, and storage are scarce resources, and generally, decrease depending on the edge location (e.g., fewer processing resources being available at consumer end point devices than at a base station or at a central office). However, the closer that the edge location is to the endpoint (e.g., UEs), the more that space and power are constrained. Thus, edge computing, as a general design principle, attempts to minimize the resources needed for network services, through the distribution of more resources which are located closer both geographically and in-network access time. In this manner, edge computing attempts to bring the compute resources to the workload data where appropriate, or, bring the workload data to the compute resources.

The following describes aspects of an edge cloud architecture that covers multiple potential deployments and addresses restrictions that some network operators or service providers may have in their own infrastructures. These include, variation of configurations based on the edge location (because edges at a base station level, for instance, may have more constrained performance and capabilities in a multi-tenant scenario); configurations based on the type of compute, memory, storage, fabric, acceleration, or like resources available to edge locations, tiers of locations, or groups of locations; the service, security, and management and orchestration capabilities; and related objectives to achieve usability and performance of end services. These deployments may accomplish processing in network layers that may be considered as “near edge”, “close edge”, “local edge”, “middle edge”, or “far edge” layers, depending on latency, distance, and timing characteristics.

Edge computing is a developing paradigm where computing is performed at or closer to the “edge” of a network, typically through the use of a compute platform (e.g., x86, AMD or ARM hardware architectures) implemented at base stations, gateways, network routers, or other devices which are much closer to end point devices producing and consuming the data. For example, edge gateway servers may be equipped with pools of memory and storage resources to perform computation in real-time for low latency use-cases (e.g., autonomous driving or video surveillance) for connected client devices. Or as an example, base stations may be augmented with compute and acceleration resources to directly process service workloads for connected user equipment, without further communicating data via backhaul networks. Or as another example, central office network management hardware may be replaced with compute hardware that performs virtualized network functions and offers compute resources for the execution of services and consumer functions for connected devices. Within edge computing networks, there may be scenarios in services in which the compute resource will be “moved” to the data, as well as scenarios in which the data will be “moved” to the compute resource. Or as an example, base station compute, acceleration and network resources can provide services to scale to workload demands on an as-needed basis by activating dormant capacity (subscription, capacity-on-demand) to manage corner cases, emergencies or to provide longevity for deployed resources over a significantly longer implemented lifecycle.

In contrast to the network architecture of FIG. 11, traditional endpoint (e.g., UE, vehicle-to-vehicle (V2V), vehicle-to-everything (V2X), etc.) applications are reliant on local device or remote cloud data storage and processing to exchange and coordinate information. A cloud data arrangement allows for long-term data collection and storage but is not optimal for highly time-varying data, such as a collision, traffic light change, etc. and may fail in attempting to meet latency challenges.

Depending on the real-time requirements in a communications context, a hierarchical structure of data processing and storage nodes may be defined in an edge computing deployment. For example, such a deployment may include local ultra-low-latency processing, regional storage, and processing as well as remote cloud data-center based storage and processing. Key performance indicators (KPIs) may be used to identify where sensor data is best transferred and where it is processed or stored. This typically depends on the ISO layer dependency of the data. For example, lower layer (PHY, MAC, routing, etc.) data typically changes quickly and is better handled locally to meet latency requirements. Higher layer data such as Application-Layer data is typically less time-critical and may be stored and processed in a remote cloud data-center.

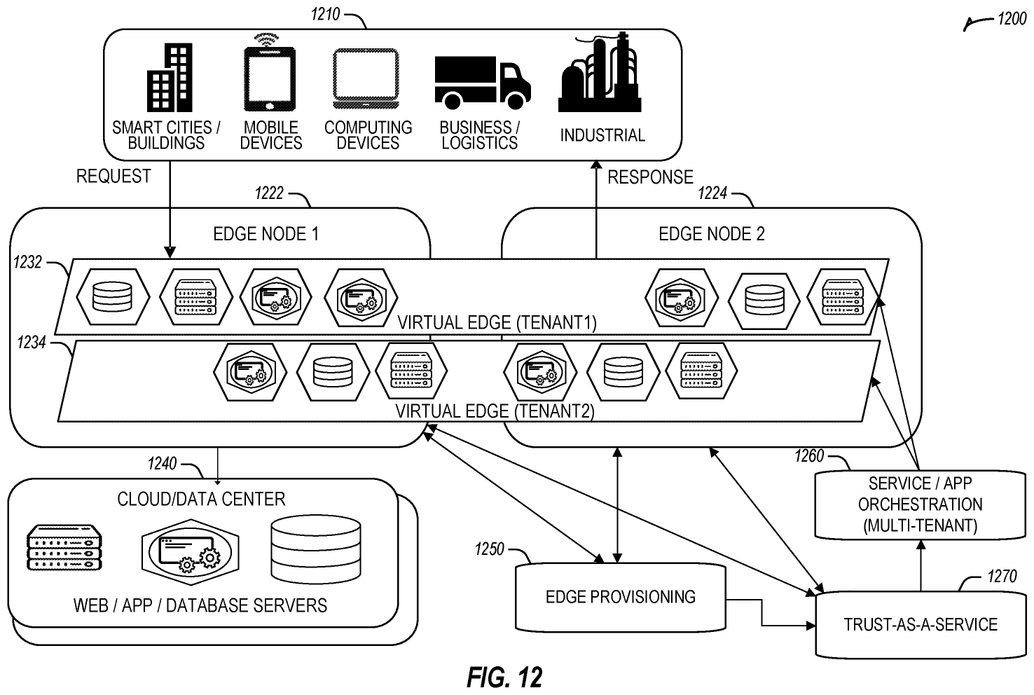

FIG. 12 illustrates deployment and orchestration for virtual edge configurations across an edge computing system operated among multiple edge nodes and multiple tenants. Specifically, FIG. 12 depicts coordination of a first edge node 1222 and a second edge node 1224 in an edge computing system 1200, to fulfill requests and responses for various client endpoints 1210 (e.g., smart cities/building systems, mobile devices, computing devices, business/logistics systems, industrial systems, etc.), which access various virtual edge instances. The virtual edge instances 232, 234 (or virtual edges) provide edge compute capabilities and processing in an edge cloud, with access to a cloud/data center 1240 for higher-latency requests for websites, applications, database servers, etc. Thus, the edge cloud enables coordination of processing among multiple edge nodes for multiple tenants or entities.

In the example of FIG. 12, these virtual edge instances include a first virtual edge 1232, offered to a first tenant (Tenant 1), which offers a first combination of edge storage, computing, and services; and a second virtual edge 1234, offering a second combination of edge storage, computing, and services, to a second tenant (Tenant 2). The virtual edge instances 1232, 1234 are distributed among the edge nodes 1222, 1224, and may include scenarios in which a request and response are fulfilled from the same or different edge nodes. The configuration of each edge node 1222, 1224 to operate in a distributed yet coordinated fashion occurs based on edge provisioning functions 1250. The functionality of the edge nodes 1222, 1224 to provide coordinated operation for applications and services, among multiple tenants, occurs based on orchestration functions 1260.

It should be understood that some of the devices in 1210 are multi-tenant devices where Tenant1 may function within a Tenant1 ‘slice’ while a Tenant2 may function within a Tenant2 ‘slice’ (and, in further examples, additional or sub-tenants may exist; and each tenant may even be specifically entitled and transactionally tied to a specific set of features all the way to specific hardware features). A trusted multi-tenant device may further contain a tenant-specific cryptographic key such that the combination of a key and a slice may be considered a “root of trust” (RoT) or tenant-specific RoT. A RoT may further be computed dynamically composed using a security architecture, such as a DICE (Device Identity Composition Engine) architecture where a DICE hardware building block is used to construct layered trusted computing base contexts for secured and authenticated layering of device capabilities (such as with use of a Field Programmable Gate Array (FPGA)). The RoT also may be used for a trusted computing context to support respective tenant operations, etc. Use of this RoT and the security architecture may be enhanced by the attestation operations further discussed herein.

Edge computing nodes may partition resources (memory, central processing unit (CPU), graphics processing unit (GPU), interrupt controller, input/output (I/O) controller, memory controller, bus controller, etc.) where respective partitionings may contain a RoT capability and where fan-out and layering according to a DICE model may further be applied to Edge Nodes. Cloud computing nodes consisting of containers, FaaS (function as a service) engines, servlets, servers, or other computation abstraction may be partitioned according to a DICE layering and fan-out structure to support a RoT context for each. Accordingly, the respective RoTs spanning devices in 1210, 1222, and 1240 may coordinate the establishment of a distributed trusted computing base (DTCB) such that a tenant-specific virtual trusted secure channel linking all elements end-to-end can be established.

Further, it will be understood that a container may have data or workload-specific keys protecting its content from a previous edge node. As part of the migration of a container, a pod controller at a source edge node may obtain a migration key from a target edge node pod controller where the migration key is used to wrap the container-specific keys. When the container/pod is migrated to the target edge node, the unwrapping key is exposed to the pod controller that then decrypts the wrapped keys. The keys may now be used to perform operations on container specific data. The migration functions may be gated by properly attested edge nodes and pod managers (as described above).

As an example, the edge computing system may be extended to provide orchestration of multiple applications through the use of containers (a contained, deployable unit of software that provides code and needed dependencies), in a multi-owner, multi-tenant environment. A multi-tenant orchestrator may be used to perform key management, trust anchor management, and other security functions related to the provisioning and lifecycle of the trusted ‘slice’ concept in FIG. 12. An orchestrator may use a DICE layering and fan-out construction to create a root of trust context that is tenant specific. Thus, orchestration functions, provided by an orchestrator, may participate as a tenant-specific orchestration provider.

Accordingly, an edge-computing system may be configured to fulfill requests and responses for various client endpoints from multiple virtual edge instances (and, from a cloud or remote data center, not shown). The use of these virtual edge instances supports multiple tenants and multiple applications (e.g., augmented reality (AR)/virtual reality (VR), enterprise applications, content delivery, gaming, compute offload) simultaneously. Further, there may be multiple types of applications within the virtual edge instances (e.g., normal applications, latency-sensitive applications, latency-critical applications, user plane applications, networking applications, etc.). The virtual edge instances may also be spanned across systems of multiple owners at different geographic locations (or, respective computing systems and resources which are co-owned or co-managed by multiple owners).

For instance, each edge node 1222, 1224 may implement the use of containers, such as with the use of a container “pod” 1226, 1228 providing a group of one or more containers. In a setting that uses one or more container pods, a pod controller or orchestrator is responsible for local control and orchestration of the containers in the pod. Various edge node resources (e.g., storage, compute, services, depicted with hexagons) provided for the respective edge slices of virtual edges 1232, 1234 are partitioned according to the needs of each container.

With the use of container pods, a pod controller oversees the partitioning and allocation of containers and resources. The pod controller receives instructions from an orchestrator (e.g., performing orchestration functions 1260) that instructs the controller on how best to partition physical resources and for what duration, such as by receiving key performance indicator (KPI) targets based on SLA contracts. The pod controller determines which container requires which resources and for how long to complete the workload and satisfy the SLA. The pod controller also manages container lifecycle operations such as: creating the container, provisioning it with resources and applications, coordinating intermediate results between multiple containers working on a distributed application together, dismantling containers when workload completes, and the like. Additionally, a pod controller may serve a security role that prevents the assignment of resources until the right tenant authenticates or prevents provisioning of data or a workload to a container until an attestation result is satisfied.

Also, with the use of container pods, tenant boundaries can still exist but in the context of each pod of containers. If each tenant-specific pod has a tenant-specific pod controller, there may be a shared pod controller that consolidates resource allocation requests to avoid typical resource starvation situations. Further controls may be provided to ensure the attestation and trustworthiness of the pod and pod controller. For instance, the orchestrator 1260 may provision an attestation verification policy to local pod controllers that perform attestation verification. If an attestation satisfies a policy for a first tenant pod controller but not a second tenant pod controller, then the second pod may be migrated to a different edge node that does satisfy it. Alternatively, the first pod may be allowed to execute and a different shared pod controller is installed and invoked before the second pod executing.

In further examples, edge computing systems may deploy containers in an edge computing system. As a simplified example, a container manager is adapted to launch containerized pods, functions, and functions-as-a-service instances through execution via compute nodes, or to separately execute containerized virtualized network functions through execution via compute nodes. This arrangement may be adapted for use by multiple tenants in system arrangement, where containerized pods, functions, and functions-as-a-service instances are launched within virtual machines specific to each tenant (aside from the execution of virtualized network functions).

Within the edge cloud, a first edge node 1222 (e.g., operated by a first owner) and a second edge node 1224 (e.g., operated by a second owner) may operate or respond to a container orchestrator to coordinate the execution of various applications within the virtual edge instances offered for respective tenants. For instance, the edge nodes 1222, 1224 may be coordinated based on edge provisioning functions 1250, while the operation of the various applications is coordinated with orchestration functions 1260.

Various system arrangements may provide an architecture that treats VMs, Containers, and Functions equally in terms of application composition (and resulting applications are combinations of these three ingredients). Each ingredient may involve the use of one or more accelerator (e.g., FPGA, ASIC) components as a local backend. In this manner, applications can be split across multiple edge owners, coordinated by an orchestrator.

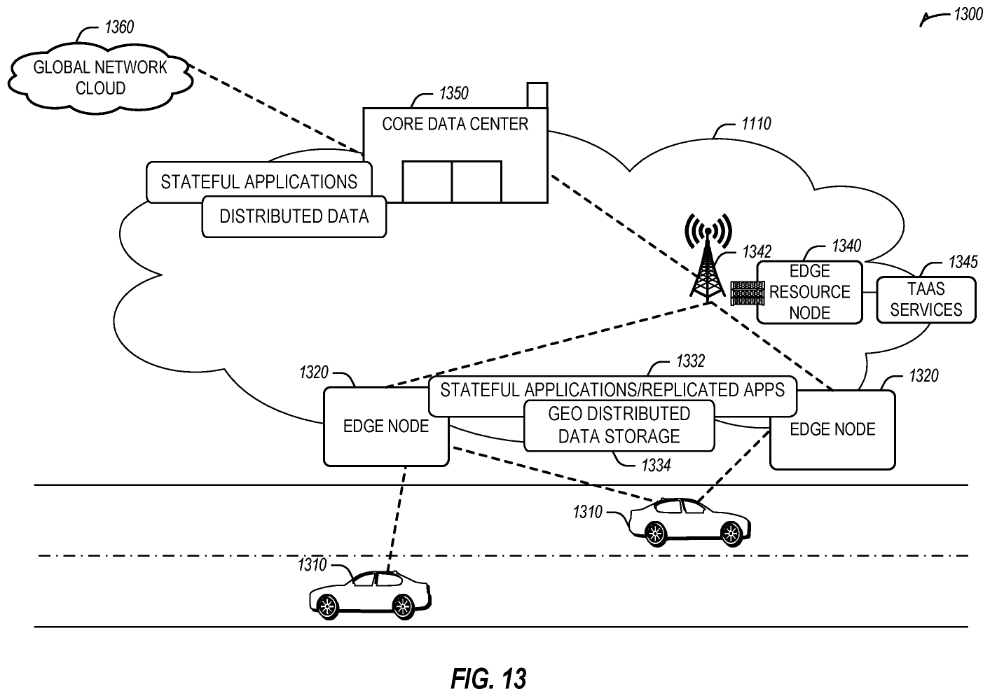

It should be appreciated that the edge computing systems and arrangements discussed herein may be applicable in various solutions, services, and/or use cases. As an example, FIG. 13 shows a simplified vehicle compute and communication use case involving mobile access to applications in an edge computing system 1300 that implements an edge cloud 1110 connected to Trust-as-a-service instances 1345. In this use case, each client compute node 1310 may be embodied as in-vehicle compute systems (e.g., in-vehicle navigation and/or infotainment systems) located in corresponding vehicles that communicate with the edge gateway nodes 1320 during traversal of a roadway. For instance, edge gateway nodes 1320 may be located in roadside cabinets, which may be placed along the roadway, at intersections of the roadway, or other locations near the roadway. As each vehicle traverses along the roadway, the connection between its client compute node 1310 and a particular edge gateway node 1320 may propagate to maintain a consistent connection and context for the client compute node 1310. Each of the edge gateway nodes 1320 includes some processing and storage capabilities and, as such, some processing and/or storage of data for the client compute nodes 1310 may be performed on one or more of the edge gateway nodes 1320.

Each of the edge gateway nodes 1320 may communicate with one or more edge resource nodes 1340, which are illustratively embodied as compute servers, appliances or components located at or in a communication base station 1342 (e.g., a base station of a cellular network). As discussed above, each edge resource node 1340 includes some processing and storage capabilities, and, as such, some processing and/or storage of data for the client compute nodes 1310 may be performed on the edge resource node 1340. For example, the processing of data that is less urgent or important may be performed by the edge resource node 1340, while the processing of data that is of a higher urgency or importance may be performed by edge gateway devices or the client nodes themselves (depending on, for example, the capabilities of each component). Further, various wired or wireless communication links (e.g., fiber optic wired backhaul, 5G wireless links) may exist among the edge nodes 1320, edge resource node(s) 1340, core data center 1350, and network cloud 1360.

The edge resource node(s) 1340 also communicate with the core data center 1350, which may include compute servers, appliances, and/or other components located in a central location (e.g., a central office of a cellular communication network). The core data center 1350 may provide a gateway to the global network cloud 1360 (e.g., the Internet) for the edge cloud 1110 operations formed by the edge resource node(s) 1340 and the edge gateway nodes 1320. Additionally, in some examples, the core data center 1350 may include an amount of processing and storage capabilities and, as such, some processing and/or storage of data for the client compute devices may be performed on the core data center 1350 (e.g., processing of low urgency or importance, or high complexity). The edge gateway nodes 1320 or the edge resource nodes 1340 may offer the use of stateful applications 1332 and a geographically distributed data storage 1334 (e.g., database, data store, etc.).

In further examples, FIG. 13 may utilize various types of mobile edge nodes, such as an edge node hosted in a vehicle (e.g., car, truck, tram, train, etc.) or other mobile units, as the edge node will move to other geographic locations along the platform hosting it. With vehicle-to-vehicle communications, individual vehicles may even act as network edge nodes for other cars, (e.g., to perform caching, reporting, data aggregation, etc.). Thus, it will be understood that the application components provided in various edge nodes may be distributed in a variety of settings, including coordination between some functions or operations at individual endpoint devices or the edge gateway nodes 1320, some others at the edge resource node 1340, and others in the core data center 1350 or the global network cloud 1360.

In further configurations, the edge computing system may implement FaaS computing capabilities through the use of respective executable applications and functions. In an example, a developer writes function code (e.g., “computer code” herein) representing one or more computer functions, and the function code is uploaded to a FaaS platform provided by, for example, an edge node or data center. A trigger such as, for example, a service use case or an edge processing event, initiates the execution of the function code with the FaaS platform.

In an example of FaaS, a container is used to provide an environment in which function code is executed. The container may be any isolated-execution entity such as a process, a Docker or Kubernetes container, a virtual machine, etc. Within the edge computing system, various datacenter, edge, and endpoint (including mobile) devices are used to “spin up” functions (e.g., activate and/or allocate function actions) that are scaled on demand. The function code gets executed on the physical infrastructure (e.g., edge computing node) device and underlying virtualized containers. Finally, the container is “spun down” (e.g., deactivated and/or deallocated) on the infrastructure in response to the execution being completed.

Further aspects of FaaS may enable deployment of edge functions in a service fashion, including support of respective functions that support edge computing as a service. Additional features of FaaS may include: a granular billing component that enables customers (e.g., computer code developers) to pay only when their code gets executed; common data storage to store data for reuse by one or more functions; orchestration and management among individual functions; function execution management, parallelism, and consolidation; management of container and function memory spaces; coordination of acceleration resources available for functions; and distribution of functions between containers (including “warm” containers, already deployed or operating, versus “cold” which require deployment or configuration).

### Example Internet of Things Architectures

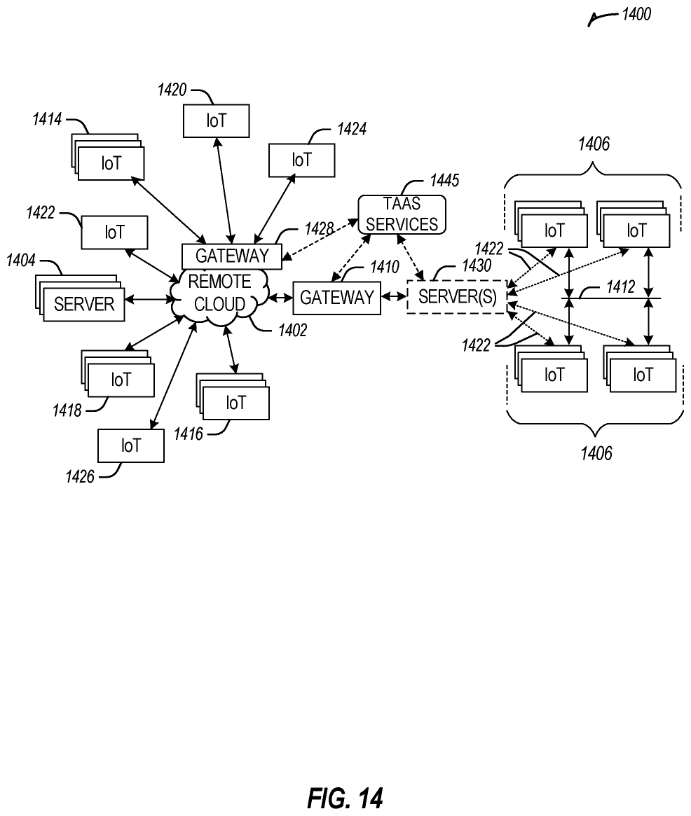

As a more detailed illustration of an Internet of Things (IoT) network, FIG. 14 illustrates a drawing of a cloud or edge computing network 1400, in communication with several IoT devices and a TaaS service 1445. The IoT is a concept in which a large number of computing devices are interconnected to each other and to the Internet to provide functionality and data acquisition at very low levels. Thus, as used herein, an IoT device may include a semiautonomous device performing a function, such as sensing or control, among others, in communication with other IoT devices and a wider network, such as the Internet.

Often, IoT devices are limited in memory, size, or functionality, allowing larger numbers to be deployed for a similar (or lower) cost compared to the cost of smaller numbers of larger devices. However, an IoT device may be a smartphone, laptop, tablet, or PC, or other larger device. Further, an IoT device may be a virtual device, such as an application on a smartphone or other computing device. IoT devices may include IoT gateways, used to couple IoT devices to other IoT devices and to cloud applications, for data storage, process control, and the like.

Networks of IoT devices may include commercial and home automation devices, such as water distribution systems, electric power distribution systems, pipeline control systems, plant control systems, light switches, thermostats, locks, cameras, alarms, motion sensors, and the like. The IoT devices may be accessible through remote computers, servers, and other systems, for example, to control systems or access data.

Returning to FIG. 14, the network 1400 may represent portions of the Internet or may include portions of a local area network (LAN), or a wide area network (WAN), such as a proprietary network for a company. The IoT devices may include any number of different types of devices, grouped in various combinations. For example, a traffic control group 1406 may include IoT devices along streets in a city. These IoT devices may include stoplights, traffic flow monitors, cameras, weather sensors, and the like. The traffic control group 406, or other subgroups, may be in communication within the network 1400 through wired or wireless links 1408, such as LPWA links, optical links, and the like. Further, a wired or wireless sub-network 1412 may allow the IoT devices to communicate with each other, such as through a local area network, a wireless local area network, and the like. The IoT devices may use another device, such as a gateway 1410 or 1428 to communicate with remote locations such as remote cloud 1402; the IoT devices may also use one or more servers 1430 to facilitate communication within the network 1400 or with the gateway 1410. For example, the one or more servers 1430 may operate as an intermediate network node to support a local edge cloud or fog implementation among a local area network. Further, the gateway 1428 that is depicted may operate in a cloud-to-gateway-to-many edge devices configuration, such as with the various IoT devices 1414, 1420, 1424 being constrained or dynamic to an assignment and use of resources in the network 1400.

In an example embodiment, the network 1400 can further include or be communicatively coupled to an Trust-a-a-Service instance or deployment configured to perform trust attestation operations within the network 1400, such as that discussed above.

Other example groups of IoT devices may include remote weather stations 1414, local information terminals 1416, alarm systems 1418, automated teller machines 1420, alarm panels 1422, or moving vehicles, such as emergency vehicles 1424 or other vehicles 1426, among many others. Each of these IoT devices may be in communication with other IoT devices, with servers 1404, with another IoT device or system, another edge computing or “fog” computing system, or a combination therein. The groups of IoT devices may be deployed in various residential, commercial, and industrial settings (including in both private or public environments).

As may be seen from FIG. 14, a large number of IoT devices may be communicating through the network 1400. This may allow different IoT devices to request or provide information to other devices autonomously. For example, a group of IoT devices (e.g., the traffic control group 1406) may request a current weather forecast from a group of remote weather stations 1414, which may provide the forecast without human intervention. Further, an emergency vehicle 1424 may be alerted by an automated teller machine 1420 that a burglary is in progress. As the emergency vehicle 1424 proceeds towards the automated teller machine 1420, it may access the traffic control group 1406 to request clearance to the location, for example, by lights turning red to block cross traffic at an intersection in sufficient time for the emergency vehicle 1424 to have unimpeded access to the intersection.

Clusters of IoT devices may be equipped to communicate with other IoT devices as well as with a cloud network. This may allow the IoT devices to form an ad-hoc network between the devices, allowing them to function as a single device, which may be termed a fog device or system. Clusters of IoT devices, such as may be provided by the remote weather stations 1414 or the traffic control group 1406, may be equipped to communicate with other IoT devices as well as with the network 1400. This may allow the IoT devices to form an ad-hoc network between the devices, allowing them to function as a single device, which also may be termed a fog device or system.

In further examples, a variety of topologies may be used for IoT networks comprising IoT devices, with the IoT networks coupled through backbone links to respective gateways. For example, a number of IoT devices may communicate with a gateway, and with each other through the gateway. The backbone links may include any number of wired or wireless technologies, including optical networks, and may be part of a local area network (LAN), a wide area network (WAN), or the Internet. Additionally, such communication links facilitate optical signal paths among both IoT devices and gateways, including the use of MUXing/deMUXing components that facilitate the interconnection of the various devices.

The network topology may include any number of types of IoT networks, such as a mesh network provided with the network using Bluetooth low energy (BLE) links. Other types of IoT networks that may be present include a wireless local area network (WLAN) network used to communicate with IoT devices through IEEE 802.11 (Wi-Fi®) links, a cellular network used to communicate with IoT devices through an LTE/LTE-A (4G) or 5G cellular network, and a low-power wide-area (LPWA) network, for example, a LPWA network compatible with the LoRaWan specification promulgated by the LoRa alliance, or an IPv6 over Low Power Wide-Area Networks (LPWAN) network compatible with a specification promulgated by the Internet Engineering Task Force (IETF).

Further, the respective IoT networks may communicate with an outside network provider (e.g., a tier 2 or tier 3 provider) using any number of communications links, such as an LTE cellular link, a LPWA link, or a link based on the IEEE 802.15.4 standard, such as Zigbee®. The respective IoT networks may also operate with the use of a variety of network and internet application protocols such as the Constrained Application Protocol (CoAP). The respective IoT networks may also be integrated with coordinator devices that provide a chain of links that forms a cluster tree of linked devices and networks.

IoT networks may be further enhanced by the integration of sensing technologies, such as sound, light, electronic traffic, facial and pattern recognition, smell, vibration, into the autonomous organizations among the IoT devices. The integration of sensory systems may allow systematic and autonomous communication and coordination of service delivery against contractual service objectives, orchestration, and quality of service (QoS) based swarming and fusion of resources.

An IoT network, arranged as a mesh network, for instance, may be enhanced by systems that perform inline data-to-information transforms. For example, self-forming chains of processing resources comprising a multi-link network may distribute the transformation of raw data to information in an efficient manner, and the ability to differentiate between assets and resources and the associated management of each. Furthermore, the proper components of infrastructure and resource-based trust and service indices may be inserted to improve the data integrity, quality, assurance, and deliver a metric of data confidence.

### Example Computing Devices

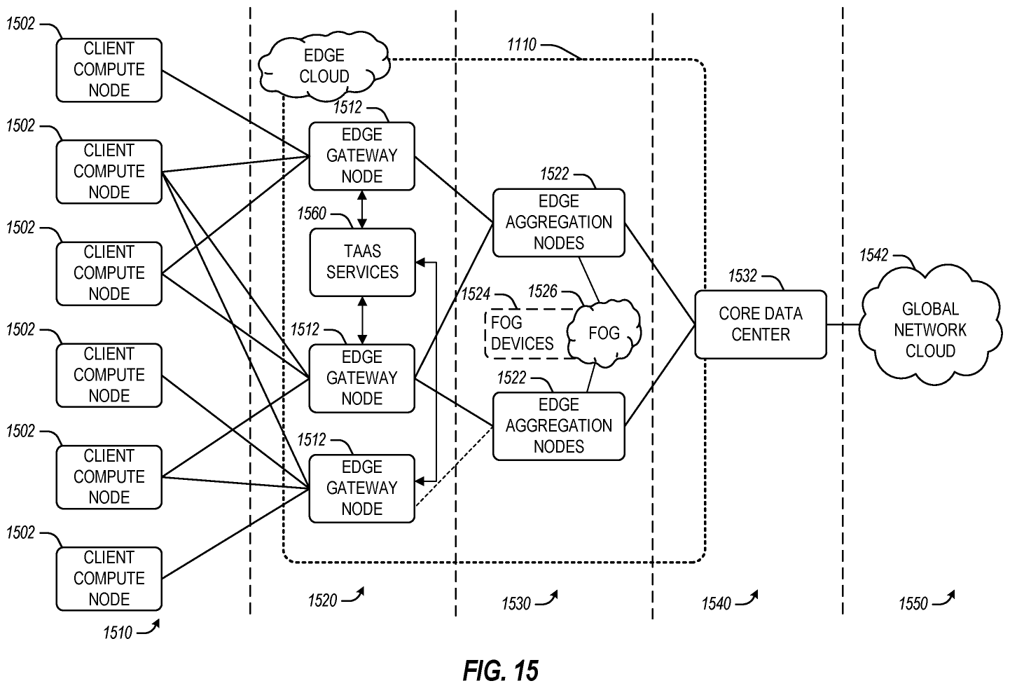

At a more generic level, an edge computing system may be described to encompass any number of deployments operating in the edge cloud 1110, which provide coordination from client and distributed computing devices. FIG. 15 provides a further abstracted overview of layers of distributed compute deployed among an edge computing environment for purposes of illustration.

FIG. 15 generically depicts an edge computing system for providing edge services and applications to multi-stakeholder entities, as distributed among one or more client compute nodes 1502, one or more edge gateway nodes 1512, one or more edge aggregation nodes 1522, one or more core data centers 1532, and a global network cloud 1542, as distributed across layers of the network. The implementation of the edge computing system may be provided at or on behalf of a telecommunication service provider (“telco”, or “TSP”), internet-of-things service provider, a cloud service provider (CSP), enterprise entity, or any other number of entities. Various forms of wired or wireless connections may be configured to establish connectivity among the nodes 1502, 1512, 1522, 1532, including interconnections among such nodes (e.g., connections among edge gateway nodes 1512, and connections among edge aggregation nodes 1522). Such connectivity and federation of these nodes may be assisted with the use of TaaS services 2560 and service instances, as discussed herein.

Each node or device of the edge computing system is located at a particular layer corresponding to layers 1510, 1520, 1530, 1540, and 1550. For example, the client compute nodes 1502 are each located at an endpoint layer 1510, while each of the edge gateway nodes 1512 is located at an edge devices layer 1520 (local level) of the edge computing system. Additionally, each of the edge aggregation nodes 1522 (and/or fog devices 1524, if arranged or operated with or among a fog networking configuration 1526) is located at a network access layer 1530 (an intermediate level). Fog computing (or “fogging”) generally refers to extensions of cloud computing to the edge of an enterprise's network, typically in a coordinated distributed or multi-node network. Some forms of fog computing provide the deployment of compute, storage, and networking services between end devices and cloud computing data centers, on behalf of the cloud computing locations. Such forms of fog computing provide operations that are consistent with edge computing as discussed herein; many of the edge computing aspects discussed herein apply to fog networks, fogging, and fog configurations. Further, aspects of the edge computing systems discussed herein may be configured as a fog, or aspects of a fog may be integrated into an edge computing architecture.

The core data center 1532 is located at a core network layer 1540 (e.g., a regional or geographically-central level), while the global network cloud 1542 is located at a cloud data center layer 1550 (e.g., a national or global layer). The use of “core” is provided as a term for a centralized network location—deeper in the network—which is accessible by multiple edge nodes or components; however, a “core” does not necessarily designate the “center” or the deepest location of the network. Accordingly, the core data center 1532 may be located within, at, or near the edge cloud 1110.

Although an illustrative number of client compute nodes 1502, edge gateway nodes 1512, edge aggregation nodes 1522, core data centers 1532, and global network clouds 1542 are shown in FIG. 15, it should be appreciated that the edge computing system may include more or fewer devices or systems at each layer. Additionally, as shown in FIG. 15, the number of components of each layer 1510, 1520, 1530, 1540, and 1550 generally increases at each lower level (i.e., when moving closer to endpoints). As such, one edge gateway node 1512 may service multiple client compute nodes 1502, and one edge aggregation node 1522 may service multiple edge gateway nodes 1512.

Consistent with the examples provided herein, each client compute node 1502 may be embodied as any type of end point component, device, appliance, or “thing” capable of communicating as a producer or consumer of data. Further, the label “node” or “device” as used in the edge computing system 1500 does not necessarily mean that such node or device operates in a client or minion/follower/agent role; rather, any of the nodes or devices in the edge computing system 1500 refer to individual entities, nodes, or subsystems which include discrete or connected hardware or software configurations to facilitate or use the edge cloud 1110.

As such, the edge cloud 1110 is formed from network components and functional features operated by and within the edge gateway nodes 1512 and the edge aggregation nodes 1522 of layers 1520, 1530, respectively. The edge cloud 1110 may be embodied as any type of network that provides edge computing and/or storage resources which are proximately located to radio access network (RAN) capable endpoint devices (e.g., mobile computing devices, IoT devices, smart devices, etc.), which are shown in FIG. 15 as the client compute nodes 1502. In other words, the edge cloud 1110 may be envisioned as an “edge” which connects the endpoint devices and traditional mobile network access points that serves as an ingress point into service provider core networks, including carrier networks (e.g., Global System for Mobile Communications (GSM) networks, Long-Term Evolution (LTE) networks, 5G networks, etc.), while also providing storage and/or compute capabilities. Other types and forms of network access (e.g., Wi-Fi, long-range wireless networks) may also be utilized in place of or in combination with such 3GPP carrier networks.

In some examples, the edge cloud 1110 may form a portion of or otherwise provide an ingress point into or across a fog networking configuration 1526 (e.g., a network of fog devices 1524, not shown in detail), which may be embodied as a system-level horizontal and distributed architecture that distributes resources and services to perform a specific function. For instance, a coordinated and distributed network of fog devices 1524 may perform computing, storage, control, or networking aspects in the context of an IoT system arrangement. Other networked, aggregated, and distributed functions may exist in the edge cloud 1110 between the cloud data center layer 1550 and the client endpoints (e.g., client compute nodes 1502). Some of these are discussed in the following sections in the context of network functions or service virtualization, including the use of virtual edges and virtual services which are orchestrated for multiple stakeholders.

The edge gateway nodes 1512 and the edge aggregation nodes 1522 cooperate to provide various edge services and security to the client compute nodes 1502. Furthermore, because each client compute node 1502 may be stationary or mobile, each edge gateway node 1512 may cooperate with other edge gateway devices to propagate presently provided edge services and security as the corresponding client compute node 1502 moves about a region. To do so, each of the edge gateway nodes 1512 and/or edge aggregation nodes 1522 may support multiple tenancies and multiple stakeholder configurations, in which services from (or hosted for) multiple service providers and multiple consumers may be supported and coordinated across a single or multiple compute devices.

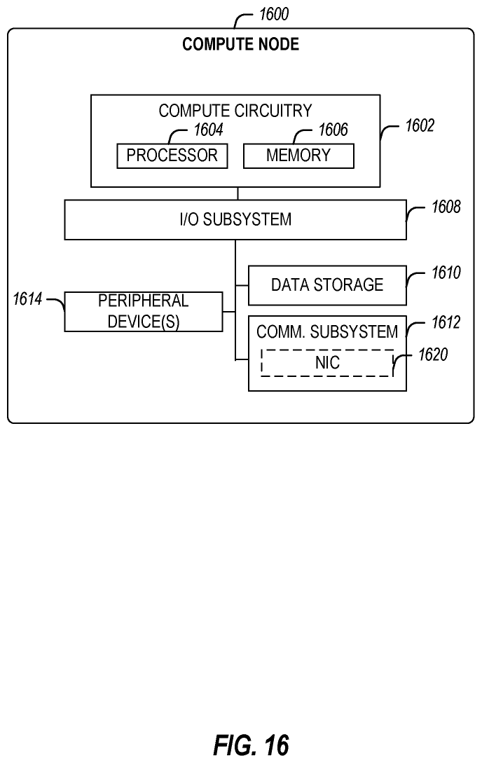

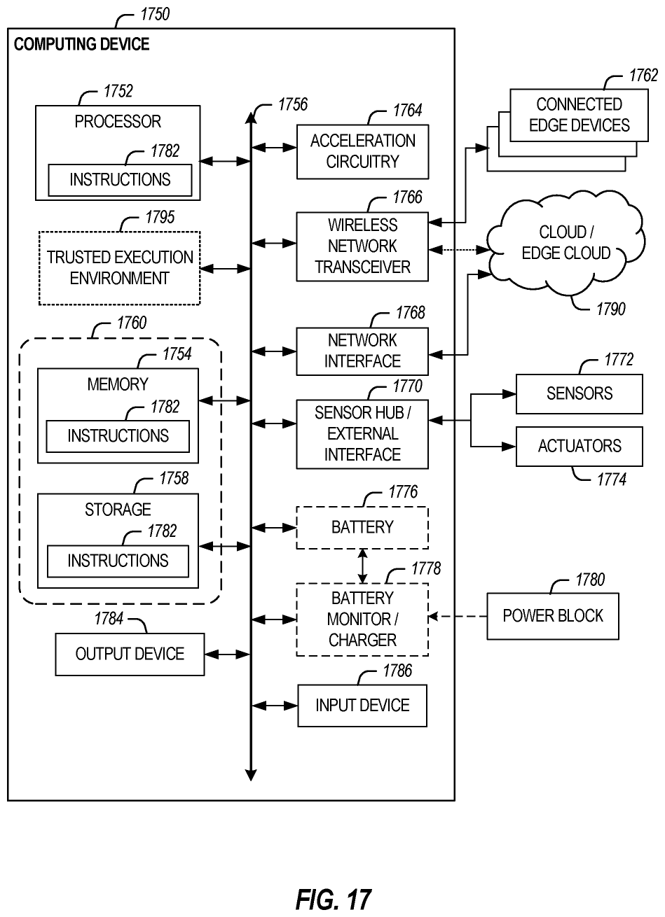

In further examples, any of the compute nodes or devices discussed with reference to the present edge computing systems and environment may be fulfilled based on the components depicted in FIGS. 16 and 17. Each edge compute node may be embodied as a type of device, appliance, computer, or other “thing” capable of communicating with other edge, networking, or endpoint components. For example, an edge compute device may be embodied as a personal computer, a server, smartphone, a mobile compute device, a smart appliance, an in-vehicle compute system (e.g., a navigation system), a self-contained device having an outer case, shell, etc., or other devices or systems capable of performing the described functions.

In the simplified example depicted in FIG. 16, an edge compute node 1600 includes a compute engine (also referred to herein as “compute circuitry”) 1602, an input/output (I/O) subsystem 1608, data storage 1610, a communication circuitry subsystem 1612, and, optionally, one or more peripheral devices 1614. In other examples, each compute device may include other or additional components, such as those used in personal or server computing systems (e.g., a display, peripheral devices, etc.). Additionally, in some examples, one or more of the illustrative components may be incorporated in, or otherwise form a portion of, another component.

The compute node 1600 may be embodied as any type of engine, device, or collection of devices capable of performing various compute functions. In some examples, the compute node 1600 may be embodied as a single device such as an integrated circuit, an embedded system, a field-programmable gate array (FPGA), a system-on-a-chip (SOC), or other integrated system or device. In the illustrative example, the compute node 1600 includes or is embodied as a processor 1604 and a memory 1606. The processor 1604 may be embodied as any type of processor capable of performing the functions described herein (e.g., executing an application). For example, the processor 1604 may be embodied as a multi-core processor(s), a microcontroller, a processing unit, a specialized or special purpose processing unit, or other processor or processing/controlling circuit. In some examples, the processor 1604 may be embodied as, include, or be coupled to an FPGA, an application-specific integrated circuit (ASIC), reconfigurable hardware or hardware circuitry, or other specialized hardware to facilitate performance of the functions described herein. Also in some examples, the processor 1604 may be embodied as a specialized x-processing unit (xPU) also known as a data processing unit (DPU), infrastructure processing unit (IPU), or network processing unit (NPU). Such an xPU may be embodied as a standalone circuit or circuit package, integrated within an SOC, or integrated with networking circuitry (e.g., in a SmartNIC, or enhanced SmartNIC), acceleration circuitry, storage devices, or AI or specialized hardware (e.g., GPUs, programmed FPGAs, Network Processing Units (NPUs), Infrastructure Processing Units (IPUs), Storage Processing Units (SPUs), AI Processors (APUs), Data Processing Unit (DPUs), or other specialized accelerators such as a cryptographic processing unit/accelerator). Such an xPU may be designed to receive programming to process one or more data streams and perform specific tasks and actions for the data streams (such as hosting microservices, performing service management or orchestration, organizing or managing server or data center hardware, managing service meshes, or collecting and distributing telemetry), outside of the CPU or general purpose processing hardware. However, it will be understood that an xPU, a SOC, a CPU, and other variations of the processor 704 may work in coordination with each other to execute many types of operations and instructions within and on behalf of the compute node 1600.

The main memory 1606 may be embodied as any type of volatile (e.g., dynamic random access memory (DRAM), etc.) or non-volatile memory or data storage capable of performing the functions described herein. Volatile memory may be a storage medium that requires power to maintain the state of data stored by the medium. Non-limiting examples of volatile memory may include various types of random access memory (RAM), such as DRAM or static random access memory (SRAM). One particular type of DRAM that may be used in a memory module is synchronous dynamic random access memory (SDRAM).

In one example, the memory device is a block addressable memory device, such as those based on NAND or NOR technologies. A memory device may also include a three-dimensional crosspoint memory device (e.g., Intel 3D XPoint™ memory), or other byte-addressable write-in-place nonvolatile memory devices. The memory device may refer to the die itself and/or to a packaged memory product. In some examples, 3D crosspoint memory (e.g., Intel 3D XPoint™ memory) may comprise a transistor-less stackable cross-point architecture in which memory cells sit at the intersection of word lines and bit lines and are individually addressable and in which bit storage is based on a change in bulk resistance. In some examples, all or a portion of the main memory 1606 may be integrated into the processor 1604. The main memory 1606 may store various software and data used during operation such as one or more applications, data operated on by the application(s), libraries, and drivers.

The compute circuitry 1602 is communicatively coupled to other components of the compute node 1600 via the I/O subsystem 1608, which may be embodied as circuitry and/or components to facilitate input/output operations with the compute circuitry 1602 (e.g., with the processor 1604 and/or the main memory 1606) and other components of the compute circuitry 1602. For example, the I/O subsystem 1608 may be embodied as, or otherwise include memory controller hubs, input/output control hubs, integrated sensor hubs, firmware devices, communication links (e.g., point-to-point links, bus links, wires, cables, light guides, printed circuit board traces, etc.), and/or other components and subsystems to facilitate the input/output operations. In some examples, the I/O subsystem 1608 may form a portion of a system-on-a-chip (SoC) and be incorporated, along with one or more of the processor 1604, the main memory 1606, and other components of the compute circuitry 1602, into the compute circuitry 1602.

The one or more illustrative data storage devices 1610 may be embodied as any type of device configured for short-term or long-term storage of data such as, for example, memory devices and circuits, memory cards, hard disk drives, solid-state drives, or other data storage devices. Each data storage device 1610 may include a system partition that stores data and firmware code for the data storage device 1610. Each data storage device 1610 may also include one or more operating system partitions that store data files and executables for operating systems depending on, for example, the type of compute node 1600.

The communication circuitry 1612 may be embodied as any communication circuit, device, or collection thereof, capable of enabling communications over a network between the compute circuitry 1602 and another compute device (e.g., an edge gateway node 1512 of the edge computing system 1500). The communication circuitry 1612 may be configured to use any one or more communication technology (e.g., wired or wireless communications) and associated protocols (e.g., a cellular networking protocol such a 3GPP 4G or 5G standard, a wireless local area network protocol such as IEEE 802.11/Wi-Fi®, a wireless wide area network protocol, Ethernet, Bluetooth®, Bluetooth Low Energy, an IoT protocol such as IEEE 802.15.4 or ZigBee®, low-power wide-area network (LPWAN) or low-power wide-area (LPWA) protocols, etc.) to effect such communication.

The illustrative communication circuitry 1612 includes a network interface controller (NIC) 1620, which may also be referred to as a host fabric interface (HFI). The NIC 1620 may be embodied as one or more add-in-boards, daughter cards, network interface cards, controller chips, chipsets, or other devices that may be used by the compute node 1600 to connect with another compute device (e.g., an edge gateway node 1512). In some examples, the NIC 1620 may be embodied as part of a system-on-a-chip (SoC) that includes one or more processors or included on a multichip package that also contains one or more processors. In some examples, the NIC 1620 may include a local processor (not shown) and/or a local memory and storage (not shown) that are local to the NIC 1620. In such examples, the local processor of the NIC 1620 (which can include general-purpose accelerators or specific accelerators) may be capable of performing one or more of the functions of the compute circuitry 1602 described herein. Additionally, or alternatively, the local memory of the NIC 1620 may be integrated into one or more components of the client compute node at the board level, socket level, chip level, and/or other levels.

Additionally, in some examples, each compute node 1600 may include one or more peripheral devices 1614. Such peripheral devices 1614 may include any type of peripheral device found in a compute device or server such as audio input devices, a display, other input/output devices, interface devices, and/or other peripheral devices, depending on the particular type of the compute node 1600. In further examples, the compute node 1600 may be embodied by a respective edge compute node in an edge computing system (e.g., client compute node 1502, edge gateway node 1512, edge aggregation node 1522) or like forms of appliances, computers, subsystems, circuitry, or other components.

In a more detailed example, FIG. 17 illustrates a block diagram of an example of components that may be present in an edge computing device (or node) 1750 for implementing the techniques (e.g., operations, processes, methods, and methodologies) described herein. The edge computing node 1750 provides a closer view of the respective components of node 1600 when implemented as or as part of a computing device (e.g., as a mobile device, a base station, server, gateway, etc.). The edge computing node 1750 may include any combinations of the components referenced above, and it may include any device usable with an edge communication network or a combination of such networks. The components may be implemented as integrated circuits (ICs), portions thereof, discrete electronic devices, or other modules, logic, instruction sets, programmable logic or algorithms, hardware, hardware accelerators, software, firmware, or a combination thereof adapted in the edge computing node 1750, or as components otherwise incorporated within a chassis of a larger system.

The edge computing node 1750 may include processing circuitry in the form of a processor 1752, which may be a microprocessor, a multi-core processor, a multithreaded processor, an ultra-low voltage processor, an embedded processor, an xPU/DPU/IPU/NPU, special purpose processing unit, specialized processing unit, or other known processing elements. The processor 1752 may be a part of a system on a chip (SoC) in which the processor 1752 and other components are formed into a single integrated circuit, or a single package, such as the Edison™ or Galileo™ SoC boards from Intel Corporation, Santa Clara, California. As an example, the processor 1752 may include an Intel® Architecture Core™ based processor, such as a Quark™, an Atom™, an i3, an i5, an i7, an i9, or an MCU-class processor, or another such processor available from Intel®. However, any number other processors may be used, such as available from Advanced Micro Devices, Inc. (AMD) of Sunnyvale, California, a MIPS-based design from MIPS Technologies, Inc. of Sunnyvale, California, an ARM-based design licensed from ARM Holdings, Ltd. or a customer thereof, or their licensees or adopters. The processors may include units such as an A5-A14 processor from Apple® Inc., a Snapdragon™ processor from Qualcomm® Technologies, Inc., or an OMAP™ processor from Texas Instruments, Inc. The processor 1752 and accompanying circuitry may be provided in a single socket form factor, multiple socket form factor, or a variety of other formats, including in limited hardware configurations or configurations that include fewer than all elements shown in FIG. 17.

The processor 1752 may communicate with a system memory 1754 over an interconnect 1756 (e.g., a bus). Any number of memory devices may be used to provide for a given amount of system memory. As examples, the memory may be random access memory (RAM) in accordance with a Joint Electron Devices Engineering Council (JEDEC) design such as the DDR or mobile DDR standards (e.g., LPDDR, LPDDR2, LPDDR3, or LPDDR4). In particular examples, a memory component may comply with a DRAM standard promulgated by JEDEC, such as JESD79F for DDR SDRAM, JESD79-2F for DDR2 SDRAM, JESD79-3F for DDR3 SDRAM, JESD79-4A for DDR4 SDRAM, JESD209 for Low Power DDR (LPDDR), JESD209-2 for LPDDR2, JESD209-3 for LPDDR3, and JESD209-4 for LPDDR4. Such standards (and similar standards) may be referred to as DDR-based standards and communication interfaces of the storage devices that implement such standards may be referred to as DDR-based interfaces. In various implementations, the individual memory devices may be of any number of different package types such as single die package (SDP), dual die package (DDP), or quad die package (Q17P). These devices, in some examples, may be directly soldered onto a motherboard to provide a lower profile solution, while in other examples the devices are configured as one or more memory modules that in turn couple to the motherboard by a given connector. Any number of other memory implementations may be used, such as other types of memory modules, e.g., dual inline memory modules (DIMMs) of different varieties including but not limited to microDIMMs or MiniDIMMs.

To provide for persistent storage of information such as data, applications, operating systems, and so forth, a storage 1758 may also couple to the processor 1752 via the interconnect 1756. In an example, the storage 1758 may be implemented via a solid-state disk drive (SSDD). Other devices that may be used for the storage 1758 include flash memory cards, such as SD cards, microSD cards, XD picture cards, and the like, and USB flash drives. In an example, the memory device may be or may include memory devices that use chalcogenide glass, multi-threshold level NAND flash memory, NOR flash memory, single or multi-level Phase Change Memory (PCM), a resistive memory, nanowire memory, ferroelectric transistor random access memory (FeTRAM), anti-ferroelectric memory, magnetoresistive random access memory (MRAM) memory that incorporates memristor technology, resistive memory including the metal oxide base, the oxygen vacancy base and the conductive bridge Random Access Memory (CB-RAM), or spin-transfer torque (STT)-MRAM, a spintronic magnetic junction memory-based device, a magnetic tunneling junction (MTJ) based device, a DW (Domain Wall) and SOT (Spin-Orbit Transfer) based device, a thyristor-based memory device, or a combination of any of the above, or other memory.

In low power implementations, the storage 1758 may be on-die memory or registers associated with the processor 1752. However, in some examples, the storage 1758 may be implemented using a micro hard disk drive (HDD) or solid-state drive (SSD). Further, any number of new technologies may be used for the storage 1758 in addition to, or instead of, the technologies described, such resistance change memories, phase change memories, holographic memories, or chemical memories, among others.

The components may communicate over the interconnect 1756. The interconnect 1756 may include any number of technologies, including industry-standard architecture (ISA), extended ISA (EISA), peripheral component interconnect (PCI), peripheral component interconnect extended (PCIx), PCI express (PCIe), or any number of other technologies. The interconnect 1756 may be a proprietary bus, for example, used in an SoC based system. Other bus systems may be included, such as an I2C interface, an SPI interface, point to point interfaces, and a power bus, among others.

The interconnect 1756 may couple the processor 1752 to a transceiver 1766, for communications with the connected edge devices 1762. The transceiver 1766 may use any number of frequencies and protocols, such as 2.4 Gigahertz (GHz) transmissions under the IEEE 802.15.4 standard, using the Bluetooth® low energy (BLE) standard, as defined by the Bluetooth® Special Interest Group, or the ZigBee® standard, among others. Any number of radios, configured for a particular wireless communication protocol, may be used for the connections to the connected edge devices 1762. For example, a wireless local area network (WLAN) unit may be used to implement Wi-Fi® communications in accordance with the Institute of Electrical and Electronics Engineers (IEEE) 802.11 standard. In addition, wireless wide area communications, e.g., according to a cellular or other wireless wide area protocol, may occur via a wireless wide area network (WWAN) unit.

The wireless network transceiver 1766 (or multiple transceivers) may communicate using multiple standards or radios for communications at a different range. For example, the edge computing node 1750 may communicate with close devices, e.g., within about 10 meters, using a local transceiver based on BLE, or another low power radio, to save power. More distant connected edge devices 1762, e.g., within about 50 meters, may be reached over ZigBee or other intermediate power radios. Both communications techniques may take place over a single radio at different power levels or may take place over separate transceivers, for example, a local transceiver using BLE and a separate mesh transceiver using ZigBee®.

A wireless network transceiver 1766 (e.g., a radio transceiver) may be included to communicate with devices or services in the edge cloud 1790 via local or wide area network protocols. The wireless network transceiver 1766 may be an LPWA transceiver that follows the IEEE 802.15.4, or IEEE 802.15.4g standards, among others. The edge computing node 1750 may communicate over a wide area using LoRaWAN™ (Long Range Wide Area Network) developed by Semtech and the LoRa Alliance. The techniques described herein are not limited to these technologies but may be used with any number of other cloud transceivers that implement long-range, low bandwidth communications, such as Sigfox, and other technologies. Further, other communications techniques, such as time-slotted channel hopping, described in the IEEE 802.15.4e specification may be used.

Any number of other radio communications and protocols may be used in addition to the systems mentioned for the wireless network transceiver 1766, as described herein. For example, the transceiver 1766 may include a cellular transceiver that uses spread spectrum (SPA/SAS) communications for implementing high-speed communications. Further, any number of other protocols may be used, such as Wi-Fi® networks for medium speed communications and provision of network communications. The transceiver 1766 may include radios that are compatible with any number of 3GPP (Third Generation Partnership Project) specifications, such as Long Term Evolution (LTE) and 5th Generation (5G) communication systems, discussed in further detail at the end of the present disclosure. A network interface controller (NIC) 1768 may be included to provide a wired communication to nodes of the edge cloud 1790 or other devices, such as the connected edge devices 1762 (e.g., operating in a mesh). The wired communication may provide an Ethernet connection or may be based on other types of networks, such as Controller Area Network (CAN), Local Interconnect Network (LIN), DeviceNet, ControlNet, Data Highway+, PROFIBUS, or PROFINET, Time Sensitive Networks (TSN), among many others. An additional NIC 1768 may be included to enable connecting to a second network, for example, a first NIC 1768 providing communications to the cloud over Ethernet, and a second NIC 1768 providing communications to other devices over another type of network.

Given the variety of types of applicable communications from the device to another component or network, applicable communications circuitry used by the device may include or be embodied by any one or more of components 1764, 1766, 1768, or 1770. Accordingly, in various examples, applicable means for communicating (e.g., receiving, transmitting, etc.) may be embodied by such communications circuitry.

The edge computing node 1750 may include or be coupled to acceleration circuitry 1764, which may be embodied by one or more AI accelerators, a neural compute stick, neuromorphic hardware, an FPGA, an arrangement of GPUs, an arrangement of xPUs/DPUs/IPU/NPUs, one or more SoCs, one or more CPUs, one or more digital signal processors, dedicated ASICs, or other forms of specialized processors or circuitry designed to accomplish one or more specialized tasks. These tasks may include AI processing (including machine learning, training, inferencing, and classification operations), visual data processing, network data processing, object detection, rule analysis, or the like. Accordingly, in various examples, applicable means for acceleration may be embodied by such acceleration circuitry.

The interconnect 1756 may couple the processor 1752 to a sensor hub or external interface 1770 that is used to connect additional devices or subsystems. The devices may include sensors 1772, such as accelerometers, level sensors, flow sensors, optical light sensors, camera sensors, temperature sensors, a global navigation system (e.g., GPS) sensors, pressure sensors, barometric pressure sensors, and the like. The hub or interface 1770 further may be used to connect the edge computing node 1750 to actuators 1774, such as power switches, valve actuators, an audible sound generator, a visual warning device, and the like.

In some optional examples, various input/output (I/O) devices may be present within or connected to, the edge computing node 1750. For example, a display or other output device 1784 may be included to show information, such as sensor readings or actuator position. An input device 1786, such as a touch screen or keypad may be included to accept input. An output device 1784 may include any number of forms of audio or visual display, including simple visual outputs such as binary status indicators (e.g., LEDs) and multi-character visual outputs, or more complex outputs such as display screens (e.g., LCD screens), with the output of characters, graphics, multimedia objects, and the like being generated or produced from the operation of the edge computing node 1750. A display or console hardware, in the context of the present system, may be used to provide output and receive input of an edge computing system; to manage components or services of an edge computing system; identify a state of an edge computing component or service; or to conduct any other number of management or administration functions or service use cases.

A battery 1776 may power the edge computing node 1750, although, in examples in which the edge computing node 1750 is mounted in a fixed location, it may have a power supply coupled to an electrical grid, or the battery may be used as a backup or for temporary capabilities. The battery 1776 may be a lithium-ion battery, or a metal-air battery, such as a zinc-air battery, an aluminum-air battery, a lithium-air battery, and the like.

A battery monitor/charger 1778 may be included in the edge computing node 1750 to track the state of charge (SoCh) of the battery 1776. The battery monitor/charger 1778 may be used to monitor other parameters of the battery 1776 to provide failure predictions, such as the state of health (SoH) and the state of function (SoF) of the battery 1776. The battery monitor/charger 1778 may include a battery monitoring integrated circuit, such as an LTC4020 or an LTC2990 from Linear Technologies, an ADT7488A from ON Semiconductor of Phoenix Arizona, or an IC from the UCD90xxx family from Texas Instruments of Dallas, TX. The battery monitor/charger 1778 may communicate the information on the battery 1776 to the processor 1752 over the interconnect 1756. The battery monitor/charger 1778 may also include an analog-to-digital (ADC) converter that enables the processor 1752 to directly monitor the voltage of the battery 1776 or the current flow from the battery 1776. The battery parameters may be used to determine actions that the edge computing node 1750 may perform, such as transmission frequency, mesh network operation, sensing frequency, and the like.

A power block 1780, or other power supply coupled to a grid, may be coupled with the battery monitor/charger 1778 to charge the battery 1776. In some examples, the power block 1780 may be replaced with a wireless power receiver to obtain the power wirelessly, for example, through a loop antenna in the edge computing node 1750. A wireless battery charging circuit, such as an LTC4020 chip from Linear Technologies of Milpitas, California, among others, may be included in the battery monitor/charger 1778. The specific charging circuits may be selected based on the size of the battery 1776, and thus, the current required. The charging may be performed using the Airfuel standard promulgated by the Airfuel Alliance, the Qi wireless charging standard promulgated by the Wireless Power Consortium, or the Rezence charging standard, promulgated by the Alliance for Wireless Power, among others.

The storage 1758 may include instructions 1782 in the form of software, firmware, or hardware commands to implement the techniques described herein. Although such instructions 1782 are shown as code blocks included in the memory 1754 and the storage 1758, it may be understood that any of the code blocks may be replaced with hardwired circuits, for example, built into an application-specific integrated circuit (ASIC).

Also in a specific example, the instructions 1782 on the processor 1752 (separately, or in combination with the instructions 1782 of the machine readable medium 1760) may configure execution or operation of a trusted execution environment (TEE) 1795. In an example, the TEE 1795 operates as a protected area accessible to the processor 1752 for secure execution of instructions and secure access to data. Various implementations of the TEE 1795, and an accompanying secure area in the processor 1752 or the memory 1754 may be provided, for instance, through use of Intel® Software Guard Extensions (SGX) or ARM® TrustZone® hardware security extensions, Intel® Management Engine (ME), or Intel® Converged Security Manageability Engine (CSME). Other aspects of security hardening, hardware roots-of-trust, and trusted or protected operations may be implemented in the edge computing node 1750 through the TEE 1795 and the processor 1752.

In an example, the instructions 1782 provided via memory 1754, the storage 1758, or the processor 1752 may be embodied as a non-transitory, machine-readable medium 1760 including code to direct the processor 1752 to perform electronic operations in the edge computing node 1750. The processor 1752 may access the non-transitory, machine-readable medium 1760 over the interconnect 1756. For instance, the non-transitory, machine-readable medium 1760 may be embodied by devices described for the storage 1758 or may include specific storage units such as optical disks, flash drives, or any number of other hardware devices. The non-transitory, machine-readable medium 1760 may include instructions to direct the processor 1752 to perform a specific sequence or flow of actions, for example, as described with respect to the flowchart(s) and block diagram(s) of operations and functionality depicted above. As used herein, the terms “machine-readable medium”, “computer-readable medium”, “machine-readable storage”, and “computer-readable storage” are interchangeable.

In an example embodiment, the edge computing node 1750 can be implemented using components/modules/blocks 1752-1786 which are configured as IP Blocks. Each IP Block may contain a hardware RoT (e.g., device identifier composition engine, or DICE), where a DICE key may be used to identify and attest the IP Block firmware to a peer IP Block or remotely to one or more of components/modules/blocks 1762-1780. Thus, it will be understood that the node 1750 itself may be implemented as a SoC or standalone hardware package.

In further examples, a machine-readable medium also includes any tangible medium that is capable of storing, encoding or carrying instructions for execution by a machine and that cause the machine to perform any one or more of the methodologies of the present disclosure or that is capable of storing, encoding or carrying data structures utilized by or associated with such instructions. A “machine-readable medium” thus may include but is not limited to, solid-state memories, and optical and magnetic media. Specific examples of machine-readable media include non-volatile memory, including but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks. The instructions embodied by a machine-readable medium may further be transmitted or received over a communications network using a transmission medium via a network interface device utilizing any one of a number of transfer protocols (e.g., HTTP).

A machine-readable medium may be provided by a storage device or other apparatus which is capable of hosting data in a non-transitory format. In an example, information stored or otherwise provided on a machine-readable medium may be representative of instructions, such as instructions themselves or a format from which the instructions may be derived. This format from which the instructions may be derived may include source code, encoded instructions (e.g., in compressed or encrypted form), packaged instructions (e.g., split into multiple packages), or the like. The information representative of the instructions in the machine-readable medium may be processed by processing circuitry into the instructions to implement any of the operations discussed herein. For example, deriving the instructions from the information (e.g., processing by the processing circuitry) may include: compiling (e.g., from source code, object code, etc.), interpreting, loading, organizing (e.g., dynamically or statically linking), encoding, decoding, encrypting, unencrypting, packaging, unpackaging, or otherwise manipulating the information into the instructions.

In an example, the derivation of the instructions may include assembly, compilation, or interpretation of the information (e.g., by the processing circuitry) to create the instructions from some intermediate or preprocessed format provided by the machine-readable medium. The information, when provided in multiple parts, may be combined, unpacked, and modified to create the instructions. For example, the information may be in multiple compressed source code packages (or object code, or binary executable code, etc.) on one or several remote servers. The source code packages may be encrypted when in transit over a network and decrypted, uncompressed, assembled (e.g., linked) if necessary, and compiled or interpreted (e.g., into a library, stand-alone executable, etc.) at a local machine, and executed by the local machine.

Each of the block diagrams of FIGS. 16 and 17 is intended to depict a high-level view of components of a device, subsystem, or arrangement of an edge computing node. However, it will be understood that some of the components shown may be omitted, additional components may be present, and a different arrangement of the components shown may occur in other implementations.

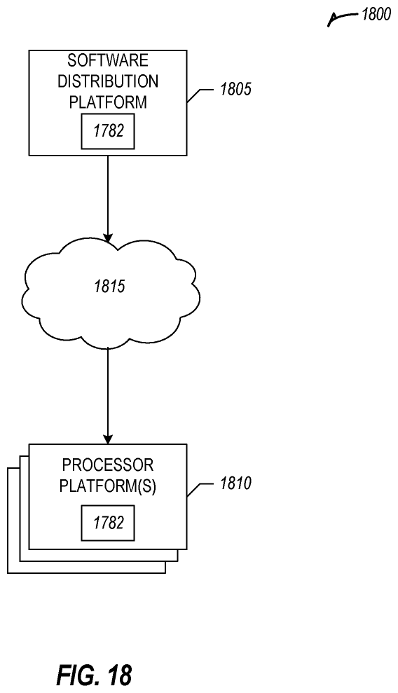

FIG. 18 illustrates an example software distribution platform 1805 to distribute software, such as the example computer readable instructions 1782 of FIG. 17, to one or more devices, such as example processor platform(s) 18 and/or other example connected edge devices or systems discussed herein. The example software distribution platform 1805 may be implemented by any computer server, data facility, cloud service, etc., capable of storing and transmitting software to other computing devices. Example connected edge devices may be customers, clients, managing devices (e.g., servers), third parties (e.g., customers of an entity owning and/or operating the software distribution platform 1805). Example connected edge devices may operate in commercial and/or home automation environments. In some examples, a third party is a developer, a seller, and/or a licensor of software such as the example computer readable instructions 1782 of FIG. 17. The third parties may be consumers, users, retailers, OEMs, etc. that purchase and/or license the software for use and/or re-sale and/or sub-licensing. In some examples, distributed software causes display of one or more user interfaces (UIs) and/or graphical user interfaces (GUIs) to identify the one or more devices (e.g., connected edge devices) geographically and/or logically separated from each other (e.g., physically separated IoT devices chartered with the responsibility of water distribution control (e.g., pumps), electricity distribution control (e.g., relays), etc.).

In the illustrated example of FIG. 18, the software distribution platform 1805 includes one or more servers and one or more storage devices that store the computer readable instructions 1782. The one or more servers of the example software distribution platform 1805 are in communication with a network 1815, which may correspond to any one or more of the Internet and/or any of the example networks described above. In some examples, the one or more servers are responsive to requests to transmit the software to a requesting party as part of a commercial transaction. Payment for the delivery, sale and/or license of the software may be handled by the one or more servers of the software distribution platform and/or via a third-party payment entity. The servers enable purchasers and/or licensors to download the computer readable instructions 1782 from the software distribution platform 1805. For example, the software, which may correspond to example computer readable instructions, may be downloaded to the example processor platform(s), which is/are to execute the computer readable instructions 1782. In some examples, one or more servers of the software distribution platform 1805 are communicatively connected to one or more security domains and/or security devices through which requests and transmissions of the example computer readable instructions 1782 must pass. In some examples, one or more servers of the software distribution platform 1805 periodically offer, transmit, and/or force updates to the software (e.g., the example computer readable instructions 1782 of FIG. 17) to ensure improvements, patches, updates, etc. are distributed and applied to the software at the end user devices.

In the illustrated example of FIG. 18, the computer readable instructions 1782 are stored on storage devices of the software distribution platform 1805 in a particular format. A format of computer readable instructions includes, but is not limited to a particular code language (e.g., Java, JavaScript, Python, C, C #, SQL, HTML, etc.), and/or a particular code state (e.g., uncompiled code (e.g., ASCII), interpreted code, linked code, executable code (e.g., a binary), etc.). In some examples, the computer readable instructions 1782 stored in the software distribution platform 1805 are in a first format when transmitted to the example processor platform(s) 1810. In some examples, the first format is an executable binary in which particular types of the processor platform(s) 1810 can execute. However, in some examples, the first format is uncompiled code that requires one or more preparation tasks to transform the first format to a second format to enable execution on the example processor platform(s) 1810. For instance, the receiving processor platform(s) 1800 may need to compile the computer readable instructions 1782 in the first format to generate executable code in a second format that is capable of being executed on the processor platform(s) 1710. In still other examples, the first format is interpreted code that, upon reaching the processor platform(s) 1810, is interpreted by an interpreter to facilitate execution of instructions.

Additional examples of the presently described method, system, and device embodiments include the following, non-limiting implementations. Each of the following non-limiting examples may stand on its own or may be combined in any permutation or combination with any one or more of the other examples provided below or throughout the present disclosure.

Example 1 is a computing device, comprising: processing circuitry to perform compute operations, wherein the processing circuitry is to perform the compute operations with use of multiple layers of an IP block of the processing circuitry, and wherein trust of the IP block is established based on attestation of a hardware root of trust (RoT) at a lower layer of the multiple layers of the IP block; and attack detection and response circuitry to: identify operational data from the processing circuitry, the operational data obtained from monitoring of an operational layer of the multiple layers of the IP block; evaluate the operational data to identify an attack condition; and provide a digital attack response to the processing circuitry, based on identification of the attack condition, the digital attack response to cause a countermeasure at the operational layer.

In Example 2, the subject matter of Example 1 optionally includes subject matter where the attack detection and response circuitry is further to, prior to identification of the attack condition: perform attestation of the IP block of the processing circuitry, based on the attestation of the multiple layers including the operational layer of the IP block; and cause provisioning at the IP block of the processing circuitry to enable the countermeasure at the operational layer.

In Example 3, the subject matter of any one or more of Examples 1-2 optionally include subject matter where the countermeasure at the operational layer is pre-provisioned to enable the countermeasure.

In Example 4, the subject matter of any one or more of Examples 1-3 optionally include subject matter where the attack detection and response circuitry includes a plurality of operational layers, and wherein the attack detection and response circuitry is further to provide attestation of the plurality of operational layers to an attestation verifier service operated by another computing device.

In Example 5, the subject matter of any one or more of Examples 1-4 optionally include subject matter where identification of the attack condition is based on at least one detection algorithm that analyzes the operational data obtained from the processing circuitry.

In Example 6, the subject matter of any one or more of Examples 1-5 optionally include subject matter where the attack detection and response circuitry is further to: communicate the operational data to an attack management service operated by another computing device; wherein the attack management service coordinates with the attack detection and response circuitry to identify the attack condition and identify the countermeasure.

In Example 7, the subject matter of any one or more of Examples 1-6 optionally include subject matter where the operational data received from the processing circuitry includes an attack detect message generated by the processing circuitry, the attack detect message including data from at least one attack detection sensor at the processing circuitry.

In Example 8, the subject matter of Example 7 optionally includes subject matter where the computing operations performed by the processing circuitry include execution of a workload in a trusted execution environment, and wherein the at least one attack detection sensor is operated for at least one of the multiple layers by using at least one: tamper sensor; traffic monitoring sensor; or bus monitoring sensor.

In Example 9, the subject matter of any one or more of Examples 1-8 optionally include subject matter where the attack condition is identified as a cyber attack, a physical attack, or a side-channel attack, and wherein the countermeasure includes at least one of: erasing memory; disabling access; halting processor operations; sandboxing; data substitution; activation of a honeypot; or a cryptographic lockdown.

In Example 10, the subject matter of any one or more of Examples 1-9 optionally include subject matter where the processing circuitry is a System-on-Chip device, and wherein the attack detection and response circuitry is a configured field programmable gate array (FPGA), Application Specific Integrated Circuit (ASIC), or Complex Programmable Logic Device (CPLD).

In Example 11, the subject matter of any one or more of Examples 1-10 optionally include subject matter where the multiple layers of the IP block are established according to a Device Identifier Composition Engine (DICE) attestation architecture, and wherein the attestation of the hardware RoT is based on attestation according to the DICE attestation architecture.

Example 12 is a method for implementing attack detection and response in a computing system, comprising operations performed by an attack detection and response engine of the computing system, the method comprising: identifying operational data from processing circuitry of the computing system, wherein the processing circuitry is to perform computing operations with use of multiple layers of the processing circuitry (e.g., of an IP block), wherein trust of the processing circuitry is established based on attestation of a hardware root of trust (RoT) at a lower layer of the multiple layers; evaluating the operational data to identify an attack condition at the processing circuitry, wherein the operational data is obtained from monitoring of an operational layer of the multiple layers; and providing a digital attack response to the processing circuitry, based on identifying the attack condition, the digital attack response to cause a countermeasure at the operational layer.

In Example 13, the subject matter of Example 12 optionally includes the processing circuitry implementing the multiple layers in at least one IP block or discrete element, and wherein the method further comprises, prior to identification of the attack condition: performing attestation of the IP block (or other discrete element) of the processing circuitry, based on the attestation of the multiple layers including the operational layer of the IP block (or other discrete element); and causing provisioning at the IP block (or other discrete element) of the processing circuitry to enable the countermeasure at the operational layer.

In Example 14, the subject matter of any one or more of Examples 12-13 optionally include subject matter where the countermeasure at the operational layer is pre-provisioned to enable the countermeasure.

In Example 15, the subject matter of any one or more of Examples 12-14 optionally include subject matter where the attack detection and response engine is implemented on attack detection and response circuitry that includes a plurality of operational layers, and wherein the attack detection and response circuitry provides attestation of the plurality of operational layers to an attestation verifier service operated by another computing system.

In Example 16, the subject matter of any one or more of Examples 12-optionally include subject matter where identifying the attack condition is based on at least one detection algorithm that analyzes the operational data obtained from the processing circuitry.

In Example 17, the subject matter of any one or more of Examples 12-16 optionally include communicating the operational data to an attack management service operated by another computing system; wherein the attack management service coordinates with the attack detection and response engine to identify the attack condition and identify the countermeasure.

In Example 18, the subject matter of any one or more of Examples 12-17 optionally include subject matter where the operational data received from the processing circuitry includes an attack detect message generated by the processing circuitry, the attack detect message including data from at least one attack detection sensor at the processing circuitry.

In Example 19, the subject matter of Example 18 optionally includes subject matter where the computing operations performed by the processing circuitry include execution of a workload in a trusted execution environment, and wherein the at least one attack detection sensor is operated for at least one of the multiple layers by using at least one: tamper sensor; traffic monitoring sensors; or bus monitoring sensor.

In Example 20, the subject matter of any one or more of Examples 12-19 optionally include subject matter where the attack condition is identified as a cyber attack, a physical attack, or a side-channel attack, and wherein the countermeasure includes at least one of: erasing memory; disabling access; halting processor operations; sandboxing; data substitution; activation of a honeypot; or a cryptographic lockdown.

In Example 21, the subject matter of any one or more of Examples 12-20 optionally include subject matter where the processing circuitry is a System-on-Chip device, and wherein the attack detection and response engine is implemented by a configured field programmable gate array (FPGA), Application Specific Integrated Circuit (ASIC), or Complex Programmable Logic Device (CPLD).

In Example 22, the subject matter of any one or more of Examples 12-21 optionally include subject matter where the layered configuration of the processing circuitry is established according to a Device Identifier Composition Engine (DICE) attestation architecture, and wherein the attestation of the hardware RoT is based on attestation according to the DICE attestation architecture.

Example 23 is at least one machine-readable storage medium capable of storing instructions thereupon, which when executed by a computing system, cause the computing system to perform the method operations of any one or more of Examples 12-21 (as implemented by attack detection and response circuitry, or corresponding operations at the processing circuitry).

Example 24 is an apparatus, comprising: an interface to compute circuitry, the compute circuitry to operate with multiple layers of hardware and software, wherein trust of the compute circuitry is established based on attestation of a hardware root of trust (RoT) at a lower layer of the multiple layers; and programmable attack detection and response circuitry to: identify operational data from the compute circuitry, the operational data obtained from monitoring of an operational layer of the multiple layers; evaluate the operational data to identify an attack condition; and provide a digital attack response to the compute circuitry, based on identification of the attack condition, the digital attack response to cause a countermeasure at the operational layer.

In Example 25, the subject matter of Example 24 optionally includes communication circuitry to communicate the operational data to an attack management service operated by another computing system; wherein the attack management service coordinates with the programmable attack detection and response circuitry to identify the attack condition and identify the countermeasure.

In Example 26, the subject matter of any one or more of Examples 24-optionally include at least one attack detection sensor, operable at the compute circuitry, to generate the operational data from monitoring of the operational layer of the multiple layers.

In Example 27, the subject matter of any one or more of Examples 24-26 optionally include wherein the programmable attack detection and response circuitry comprises: a field programmable gate array (FPGA), an Application Specific Integrated Circuit (ASIC), or a Complex Programmable Logic Device (CPLD).

In Example 28, the subject matter of any one or more of Examples 24-27 optionally include wherein the compute circuitry includes at least one of: a central processing unit (CPU) processor, a graphics processing unit (GPU) processor, or a network processor.

Example 29 is an apparatus for implementing attack detection and response, comprising: means for identifying operational data from processing circuitry of the computing system, wherein the processing circuitry is to perform computing operations with use of multiple layers of an IP block of the processing circuitry, and wherein trust of the IP block is established based on attestation of a hardware root of trust (RoT) at a lower layer of the multiple layers of the IP block; means for evaluating the operational data to identify an attack condition at the processing circuitry, wherein the operational data is obtained from monitoring of an operational layer of the multiple layers of the IP block; and means for providing a digital attack response to the processing circuitry, based on identifying the attack condition, the digital attack response to cause a countermeasure at the operational layer. Other respective means of the apparatus may correspond to respective means for components performing the method operations of any one or more of Examples 12-21.

Example 30 is at least one non-transitory machine-readable medium including instructions that, when executed by specialized circuitry, cause the specialized circuitry to perform operations to implement any of the techniques or approaches in Examples 1-29 or discussed herein.

Example 31 is a system, method, or apparatus comprising respective means to implement any of the techniques or approaches in Examples 1-29 or discussed herein.

Example 32 is a multi-tier edge computing system, comprising a plurality of edge computing nodes provided among on-premise edge, network access edge, or near edge computing settings, the plurality of edge computing nodes configured to implement any of the techniques or approaches in Examples 1-29 or discussed herein.

Example 33 is an edge computing node, operable in a layer of an edge computing network as an aggregation node, network hub node, gateway node, or core data processing node, configured to implement any of the techniques or approaches in Examples 1-29 or discussed herein.

Example 34 is an edge computing network, comprising networking and processing components configured to provide or operate a communications network, to enable an edge computing system to implement any of the techniques or approaches in Examples 1-29 or discussed herein.

Example 35 is an edge computing system configured as an edge mesh, provided with a microservice cluster, a microservice cluster with sidecars, or linked microservice clusters with sidecars, configured to implement any of the techniques or approaches in Examples 1-29 or discussed herein.

Example 36 is an edge computing system, comprising circuitry configured to implement services with one or more isolation environments provided among dedicated hardware, virtual machines, containers, or virtual machines on containers, the edge computing system configured to implement any of the techniques or approaches in Examples 1-29 or discussed herein.

Example 37 is an edge computing system, comprising networking and processing components to communicate with a user equipment device, client computing device, provisioning device, or management device to implement any of the techniques or approaches in Examples 1-29 or discussed herein.

Example 38 is networking hardware with network functions implemented thereupon, operable within an edge computing system, the network functions configured to implement any of the techniques or approaches in Examples 1-29 or discussed herein.

Example 39 is storage hardware with storage capabilities implemented thereupon, operable in an edge computing system, the storage hardware configured to implement any of the techniques or approaches in Examples 1-29 or discussed herein.

Example 40 is computation hardware with compute capabilities implemented thereupon, operable in an edge computing system, the computation hardware configured to implement any of the techniques or approaches in Examples 1-29 or discussed herein.

Example 41 is a computer program used in an edge computing system, the computer program comprising instructions, wherein execution of the program by a processing element in the edge computing system is to cause the processing element to implement any of the techniques or approaches in Examples 1-29 or discussed herein.

Example 42 is an edge computing appliance device operating as a self-contained processing system, comprising a housing, case, or shell, network communication circuitry, storage memory circuitry, and processor circuitry adapted to implement any of the techniques or approaches in Examples 1-29 or discussed herein.

Example 43 is an apparatus of an edge computing system comprising means to implement any of the techniques or approaches in Examples 1-29 or discussed herein.

Example 44 is an apparatus of an edge computing system comprising logic, modules, or circuitry to implement any of the techniques or approaches in Examples 1-30 or discussed herein.

Example 45 is an edge computing system, including respective edge processing devices and nodes to invoke or perform any of the techniques or approaches in Examples 1-29 or discussed herein.

Example 46 is an edge node operating an edge provisioning service, application or service orchestration service, virtual machine deployment, container deployment, function deployment, and compute management, within or coupled to an edge computing system, operable to invoke or perform the operations of any of the techniques or approaches in Examples 1-29 or discussed herein.

Example 47 is an edge computing system including aspects of network functions, acceleration functions, acceleration hardware, storage hardware, or computation hardware resources, operable to invoke or perform the use cases discussed herein, with use of any of the techniques or approaches in Examples 1-29 or discussed herein.

Example 48 is an edge computing node, operable in a layer of an edge computing network or edge computing system as an aggregation node, network hub node, gateway node, or core data processing node, operable in a close edge, local edge, enterprise edge, on-premise edge, near edge, middle, edge, or far edge network layer, or operable in a set of nodes having common latency, timing, or distance characteristics, operable to invoke or perform the use cases discussed herein, with use of any of the techniques or approaches in Examples 1-29 or discussed herein.

Example 49 is networking hardware, acceleration hardware, storage hardware, or computation hardware, with capabilities implemented thereupon, operable in an edge computing system to invoke or perform the use cases discussed herein, with use of any of the techniques or approaches in Examples 1-29 or discussed herein.

Example 50 is an apparatus of an edge computing system comprising: one or more processors and one or more computer-readable media comprising instructions that, when deployed and executed by the one or more processors, cause the one or more processors to invoke or perform the use cases discussed herein, with use of any of the techniques or approaches in Examples 1-29 or discussed herein.

Example 51 is one or more computer-readable storage media comprising instructions to cause an electronic device of an edge computing system, upon execution of the instructions by one or more processors of the electronic device, to invoke or perform the use cases discussed herein, with the use of any of the techniques or approaches in Examples 1-29 or discussed herein.

Implementation of the preceding techniques may be accomplished through any number of specifications, configurations, or example deployments of hardware and software. It should be understood that the functional units or capabilities described in this specification may have been referred to or labeled as components or modules, to more particularly emphasize their implementation independence. Such components may be embodied by any number of software or hardware forms. For example, a component or module may be implemented as a hardware circuit comprising custom very-large-scale integration (VLSI) circuits or gate arrays, off-the-shelf semiconductors such as logic chips, transistors, or other discrete components. A component or module may also be implemented in programmable hardware devices such as field-programmable gate arrays, programmable array logic, programmable logic devices, or the like. Components or modules may also be implemented in software for execution by various types of processors. An identified component or module of executable code may, for instance, comprise one or more physical or logical blocks of computer instructions, which may, for instance, be organized as an object, procedure, or function. Nevertheless, the executables of an identified component or module need not be physically located together but may comprise disparate instructions stored in different locations which, when joined logically together, comprise the component or module and achieve the stated purpose for the component or module.

Indeed, a component or module of executable code may be a single instruction, or many instructions, and may even be distributed over several different code segments, among different programs, and across several memory devices or processing systems. In particular, some aspects of the described process (such as code rewriting and code analysis) may take place on a different processing system (e.g., in a computer in a data center), than that in which the code is deployed (e.g., in a computer embedded in a sensor or robot). Similarly, operational data may be identified and illustrated herein within components or modules and may be embodied in any suitable form and organized within any suitable type of data structure. The operational data may be collected as a single data set, or may be distributed over different locations including over different storage devices, and may exist, at least partially, merely as electronic signals on a system or network. The components or modules may be passive or active, including agents operable to perform desired functions.

In the above Detailed Description, various features may be grouped to streamline the disclosure. However, claims may not set forth every feature disclosed herein as embodiments may feature a subset of said features. Further, embodiments may include fewer features than those disclosed in a particular example. Thus, the following claims are hereby incorporated into the Detailed Description, with a claim standing on its own as a separate embodiment.

What is claimed is:

1. An apparatus, comprising:
an interface to compute circuitry, the compute circuitry to operate with multiple layers of hardware and software, wherein trust of the compute circuitry is established based on attestation of a hardware root of trust (RoT) at a lower layer of the multiple layers; and
programmable attack detection and response circuitry to:
identify operational data from the compute circuitry, the operational data obtained from monitoring of an operational layer of the multiple layers;
evaluate the operational data to identify an attack condition; and
provide a digital attack response to the compute circuitry, based on identification of the attack condition, the digital attack response to cause a countermeasure at the operational layer.

2. The apparatus of claim 1, further comprising:
communication circuitry to communicate the operational data to an attack management service operated by another computing system;
wherein the attack management service coordinates with the programmable attack detection and response circuitry to identify the attack condition and identify the countermeasure.

3. The apparatus of claim 1, further comprising:
at least one attack detection sensor, operable at the compute circuitry, to generate the operational data from monitoring of the operational layer of the multiple layers.

4. The apparatus of claim 1, wherein the programmable attack detection and response circuitry comprises: a field programmable gate array (FPGA), an Application Specific Integrated Circuit (ASIC), or a Complex Programmable Logic Device (CPLD).

5. The apparatus of claim 1, wherein the compute circuitry includes at least one of: a central processing unit (CPU) processor, a graphics processing unit (GPU) processor, or a network processor.

6. A computing device, comprising:
processing circuitry to perform compute operations, wherein the processing circuitry is to perform the compute operations with use of multiple layers of an IP block of the processing circuitry, and wherein trust of the IP block is established based on attestation of a hardware root of trust (RoT) at a lower layer of the multiple layers of the IP block; and
attack detection and response circuitry to:
identify operational data from the processing circuitry, the operational data obtained from monitoring of an operational layer of the multiple layers of the IP block;
evaluate the operational data to identify an attack condition; and
provide a digital attack response to the processing circuitry, based on identification of the attack condition, the digital attack response to cause a countermeasure at the operational layer.

7. The computing device of claim 6, wherein the attack detection and response circuitry is further to, prior to identification of the attack condition:
perform attestation of the IP block of the processing circuitry, based on the attestation of the multiple layers including the operational layer of the IP block; and
cause provisioning at the IP block of the processing circuitry to enable the countermeasure at the operational layer.

8. The computing device of claim 6, wherein the countermeasure at the operational layer is pre-provisioned to enable the countermeasure.

9. The computing device of claim 6, wherein the attack detection and response circuitry includes a plurality of operational layers, and wherein the attack detection and response circuitry is further to provide attestation of the plurality of operational layers to an attestation verifier service operated by another computing device.

10. The computing device of claim 6, wherein identification of the attack condition is based on at least one detection algorithm that analyzes the operational data obtained from the processing circuitry.

11. The computing device of claim 6, wherein the attack detection and response circuitry is further to:
communicate the operational data to an attack management service operated by another computing device;
wherein the attack management service coordinates with the attack detection and response circuitry to identify the attack condition and identify the countermeasure.

12. The computing device of claim 6, wherein the operational data received from the processing circuitry includes an attack detect message generated by the processing circuitry, the attack detect message including data from at least one attack detection sensor at the processing circuitry.

13. The computing device of claim 12, wherein the computing operations performed by the processing circuitry include execution of a workload in a trusted execution environment, and wherein the at least one attack detection sensor is operated for at least one of the multiple layers using at least one: tamper sensor; traffic monitoring sensor; or bus monitoring sensor.

14. The computing device of claim 6, wherein the attack condition is identified as a cyber attack, a physical attack, or a side-channel attack, and wherein the countermeasure includes at least one of: erasing memory; disabling access; halting processor operations; sandboxing; data substitution; activation of a honeypot; or a cryptographic lockdown.

15. The computing device of claim 6, wherein the processing circuitry is a System-on-Chip device, and wherein the attack detection and response circuitry is a configured field programmable gate array (FPGA), Application Specific Integrated Circuit (ASIC), or Complex Programmable Logic Device (CPLD).

16. The computing device of claim 6, wherein the multiple layers of the IP block are established according to a Device Identifier Composition Engine (DICE) attestation architecture, and wherein the attestation of the hardware RoT is based on attestation according to the DICE attestation architecture.

17. A method for implementing attack detection and response in a computing system, comprising operations performed by an attack detection and response engine of the computing system, the method comprising:
identifying operational data from processing circuitry of the computing system, wherein the processing circuitry is to perform computing operations with use of multiple layers of the processing circuitry, wherein trust of the processing circuitry established based on attestation of a hardware root of trust (RoT) at a lower layer of the multiple layers;
evaluating the operational data to identify an attack condition at the processing circuitry, wherein the operational data is obtained from monitoring of an operational layer of the multiple layers; and
providing a digital attack response to the processing circuitry, based on identifying the attack condition, the digital attack response to cause a countermeasure at the operational layer.

18. The method of claim 17, wherein the processing circuitry implements the multiple layers in at least one IP block, and wherein the method further comprises, prior to identification of the attack condition:
performing attestation of the at least one IP block of the processing circuitry, based on the attestation of the multiple layers including the operational layer; and
causing provisioning at the at least one IP block of the processing circuitry to enable the countermeasure at the operational layer.

19. The method of claim 17, wherein the countermeasure at the operational layer is pre-provisioned to enable the countermeasure.

20. The method of claim 17, wherein identifying the attack condition is based on at least one detection algorithm that analyzes the operational data obtained from the processing circuitry.

21. The method of claim 17, further comprising:
communicating the operational data to an attack management service operated by another computing system;
wherein the attack management service coordinates with the attack detection and response engine to identify the attack condition and identify the countermeasure.

22. The method of claim 17, wherein the attack condition is identified as a cyber attack, a physical attack, or a side-channel attack, and wherein the countermeasure includes at least one of: erasing memory; disabling access; halting processor operations; sandboxing; data substitution; activation of a honeypot; or a cryptographic lockdown.

23. At least one non-transitory machine-readable storage medium capable of storing instructions thereupon, which when executed by a computing system, cause the computing system to perform operations comprising:
identifying operational data from processing circuitry of the computing system, wherein the processing circuitry is to perform computing operations with use of multiple layers of the processing circuitry, and wherein trust of the processing circuitry is established based on attestation of a hardware root of trust (RoT) at a lower layer of the multiple layers;
evaluating the operational data to identify an attack condition at the processing circuitry, wherein the operational data is obtained from monitoring of an operational layer of the multiple layers; and
providing a digital attack response to the processing circuitry, based on identifying the attack condition, the digital attack response to cause a countermeasure at the operational layer.

24. The at least one non-transitory machine-readable storage medium of claim 23, wherein the processing circuitry of the computing system implements the multiple layers in at least one IP block, and wherein the operations further comprise, prior to identification of the attack condition:
performing attestation of the at least one IP block, based on the attestation of the multiple layers including the operational layer; and
causing provisioning at the at least one IP block to enable the countermeasure at the operational layer.

25. The at least one non-transitory machine-readable storage medium of claim 23, the operations further comprising:
communicating the operational data to an attack management service operated by another computing system;
wherein the attack management service provides data to identify the attack condition and identify the countermeasure.
